(19) United States
(12) Patent Application Publication
(10) Pub. No.: US 2017/0188441 A1
(43) Pub. Date: Jun. 29, 2017

(54) PROGRAMMABLE LIGHT TIMER AND A METHOD OF IMPLEMENTING A PROGAMMABLE LIGHT TIMER USING A KEYPAD

(71) Applicant: Cantigny Lighting Control, LLC, Wheaton, IL (US)

(72) Inventor: John Joseph King, Wheaton, IL (US)

(21) Appl. No.: 15/239,764

(22) Filed: Aug. 17, 2016

Related U.S. Application Data
(63) Continuation-in-part of application No. 14/979,377, filed on Dec. 27, 2015.

(51) Int. Cl. H05B 37/02

(52) U.S. Cl. CPC H05B 37/0281

(57) ABSTRACT

A programmable light timer for implementing a timing pattern is described. The programmable light timer comprises a numeric keypad enabling the selection of data for programming the programmable light timer; and a programming interface having one or more buttons enabling a selection of an on time or an off time associated with a button for implementing the timing pattern; wherein the on time or the off time associated with the button is programmable suing the numeric keypad.

### FIELD OF THE INVENTION

The present invention relates generally to lighting control products, and in particular, to a programmable light timer and a method of implementing a programmable light timer using a numeric keypad. Applicant claims priority to U.S. application Ser. No. 14/979,377 (Attorney Docket No. CEIC 501) filed on Dec. 27, 2015.

### BACKGROUND OF THE INVENTION

Conventional timers for lights, such as timers for indoor lamps or outdoor lights for example, either provide little functionality, or are difficult to program. Because of the limited size of the conventional timers, the size of the screen and the size of the interface for programming the timer are both relatively small. This is particularly true of an in-wall timer, which must fit in an electrical box, commonly called a junction box. Not only does a user of the in-wall timer have to read a very small display, but the user has to advance through a menu shown on the small display using a very limited interface which is provided on the remaining portion of the timer. Entering data on such a user interface is particularly difficult because the in-wall timer is fixed and generally positioned well below eye level.

Further, conventional timers are often unreliable. For example, conventional mechanical timers often malfunction over time, leaving the user without the use of the timer for some period of time and requiring the user to incur the expense of replacing the timer. Moreover, advanced digital timers having electronic displays may be difficult to operate, providing a barrier to certain groups of people who would otherwise use a timer, but don't want to struggle through a complex interface on the small screen of the timer to properly set the timer. For example, not only is the display very small and difficult to read, but the user interface is difficult to navigate on such a small display. These groups of users are either left with no timing operation for their lights, or timers which do not provide the timing operation that they desire. Without an effective timer for a light for example, the light may be on significantly longer than necessary, not only wasting energy but in many cases increasing pollution as a result. As energy consumption world-wide continues to increase, it is important to reduce or minimize the consumption of energy in any way possible. The timer of the present invention provides significant benefits in reducing energy consumption.

In addition to being difficult to program, conventional timers may have to be reprogrammed several times a year in order to compensate for changes is dusk and dawn times, commonly referred to as astronomic times, as the seasons change. While some conventional timers address changes in dusk and dawn times by allowing a user to select dusk and dawn times to be selected as one or both of an on time and an off time for a timer. However, selecting dusk or down for an on time or an off time on a menu-based user interface is particularly difficult.

Accordingly, improved arrangements and methods for programming timers a numeric keypad are beneficial.

### SUMMARY OF THE INVENTION

A programmable light timer for implementing a timing pattern is described. The programmable light timer comprises a numeric keypad enabling the selection of data for programming the programmable light timer; and a programming interface having one or more buttons enabling a selection of an on time or an off time associated with a button for implementing the timing pattern; wherein the on time or the off time associated with the button is programmable using the numeric keypad.

Another programmable light timer for implementing a timing pattern comprises a numeric keypad enabling the selection of data for programming the programmable light timer; and a programming interface having one or more dedicated programming buttons enabling a selection of data associated with implementing the timer; wherein buttons of the numeric keypad comprise multi-function buttons that enable the selection of a number associated with a button during a programming operation and a timing pattern during a timing operation.

A further programmable light timer for implementing a timing pattern comprises a numeric keypad enabling the selection of data for programming the programmable light timer; and a programming interface having one or more dedicated programming buttons enabling a selection of data associated with implementing the timer; wherein buttons of the numeric keypad comprise multi-function buttons that enable the selection of a number associated with a button during a programming operation and a timing pattern during a timer operation.

### BRIEF DESCRIPTION OF THE DRAWINGS

FIG. 1 is a perspective view of a front panel of an in-wall light timer having a cover according to an implementation of the present invention;

FIG. 2 is a perspective view of the front panel of the in-wall light timer of FIG. 1 with a cover open according to an implementation of the present invention;

FIG. 3 is a perspective view of a front panel of an in-wall light timer having a cover and an exposed display and on/off actuator according to implementation of the present invention;

FIG. 4 is another perspective view of a front panel of an in-wall light timer having a cover and an exposed display according to implementation of the present invention;

FIG. 5 is a side view of any of the timers of FIGS. 1-4 enabling the coupling of connectors on the timer to building wiring;

FIG. 6 is a side view of a lamp timer configured to receive a plug and having electrical prongs that are configured to be plugged into a wall outlet;

FIG. 7 is a block diagram of a circuit enabling the implementation of circuits and methods for operating a programmable light timer;

FIG. 8 is a block diagram of a circuit enabling the implementation of circuits and methods for operating a programmable light timer having a slot for receiving a portable memory;

FIG. 9 is a block diagram of a circuit enabling the implementation of circuits and methods for operating a programmable light timer using one or more wireless communication connections;

FIG. 10 is a block diagram of an exemplary wireless communication circuit enabling the operation of the circuit of FIG. 9 according to an implementation of the present invention;

FIG. 11 is a segmented map showing geographic regions of operation for a timer according to an implementation of the present invention;

FIG. 12 is a table having zip codes and corresponding regions;

FIG. 13 is a front plan view showing an actuator arrangement of a programmable light timer;

FIG. 14 is a front plan view showing an actuator arrangement of a programmable light timer having additional time actuators and having weekday and weekend programmable buttons;

FIG. 15 is a front plan view showing an actuator arrangement of a programmable light timer having an astronomic selection button and additional actuators for selecting a day of a year;

FIG. 16 is a front plan view showing an actuator arrangement of a programmable light timer having programmable on and off times, and on and off times associated with particular time periods of a day;

FIG. 17 is a front plan view showing an actuator arrangement of a programmable light timer having user programmable on and off times for two different times of a day using single time programmable buttons;

FIG. 18 is a front plan view showing an actuator arrangement of a programmable light timer having programmable buttons associated with predetermined times of the day;

FIG. 19 is a front plan view showing an actuator arrangement of a programmable light timer having programmable buttons associated with predetermined times of the day including dusk or dawn as pre-programmed on or off times for user programmable buttons;

FIG. 20 is a front plan view showing an actuator arrangement of a programmable light timer having a numeric keypad for enabling the selection of on and off times and the selection of dusk or dawn times as on or off times;

FIG. 21 is a flow chart showing a method of enabling the entry of time/date information, geographic data, and programming data for programmable buttons;

FIG. 22 is a flow chart showing a method of entering a current time for the timer using actuators of a programming interface of the timer;

FIG. 23 is a flow chart showing a method of entering a current time for the timer using separate hour and minute actuators of a programming interface of the timer;

FIG. 24 is a flow chart showing a method of entering a current day for the timer using actuators of the programming interface of the timer;

FIG. 25 is a flow chart showing a method of entering a current day for the timer using separate day, month and year actuators of the programming interface of the timer;

FIG. 26 is a flow chart showing a method of selecting a geographic location, also known as a zone, in which the timer is operating;

FIG. 27 is a flow chart showing enabling programming a programmable button for turning on or off at dusk or dawn using an actuator of the programming interface;

FIG. 28 is a flow chart showing enabling programming a programmable button for both turning on or off, including at least one of dusk or dawn, using an actuator of the programming interface;

FIG. 29 shows a sequence, shown on a display of a programmable light timer, during the selection of a dusk or dawn time associated with the operation of time programming buttons;

FIG. 30 shows a sequence, shown on a display of a programmable light timer, of a review/programming function according to the method of FIG. 28;

FIG. 31 shows a sequence, shown on a display of a programmable light timer, during the selection of a dusk or dawn time associated with the operation of a dedicated button;

FIG. 32 is a flow chart showing a method of implementing a programmable timer;

FIG. 33 is a diagram showing an implementation of a timer having a numeric keypad with multi-functional keys;

FIG. 34 is a diagram showing another implementation of a timer having a numeric keypad with multi-functional keys;

FIG. 35 is a diagram showing an implementation of a timer having a numeric keypad with multi-functional keys that is paired with a motion detector;

FIG. 36 is a block diagram of a timer and a motion detector;

FIG. 37 is a block diagram showing a plurality of timers paired with a plurality of motion detectors;

FIG. 38 is a flow chart showing a method of implementing a numeric keypad having multi-functional keys;

FIG. 39 is a flow chart showing a method of implementing a numeric keypad having multi-functional keys;

FIG. 40 is a flow chart showing a method of programming a programmable button of a timer; and

FIG. 41 is a flow chart showing a method of enabling the operation of two motion detectors associated with a timer.

### DETAILED DESCRIPTION OF THE DRAWINGS

The various implementations set forth below overcome significant problems with programming conventional timers having a small display, and navigating a menu on such a small display. More particularly, the programming interface and methods eliminate the need to implement a menu-based timer by enabling the simple programming of dedicated buttons that can be selected to implement on or off times of a timing pattern, including astronomic times associated with the location of the programmable light timer. That is, rather than requiring a user to enter a programming mode through a menu-based programming interface, individual dedicated buttons having at least one on time or one off time are programmed using a programming interface adapted to program the individual dedicated buttons. According to various implementation, a dedicated button that is programmable to include at least one on time or one off time can be selected and then programmed using dedicated actuators on the programming interface to program the programmable button. That is, rather than entering a programming mode for programming on and off times for a timer, a programmable button is selected, and any steps for programming the buttons are performed for that button using actuators to increment or decrement a value or a dedicated astronomic actuator. The various implementations are particularly advantageous to select astronomic times when implementing a programmable timer.

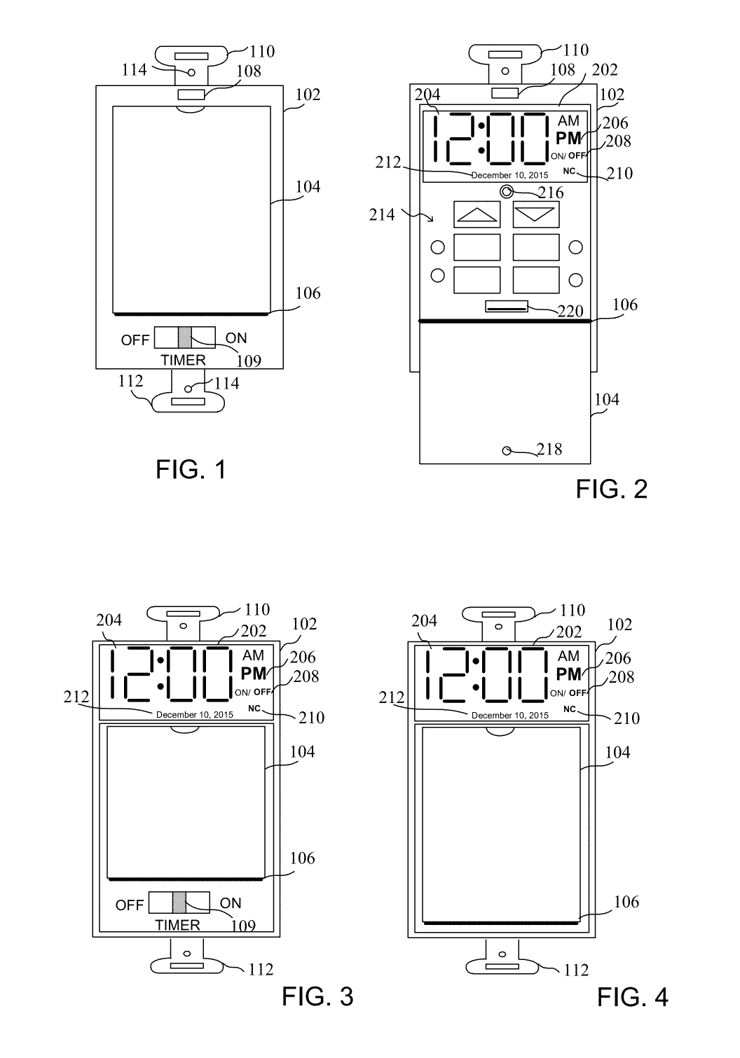

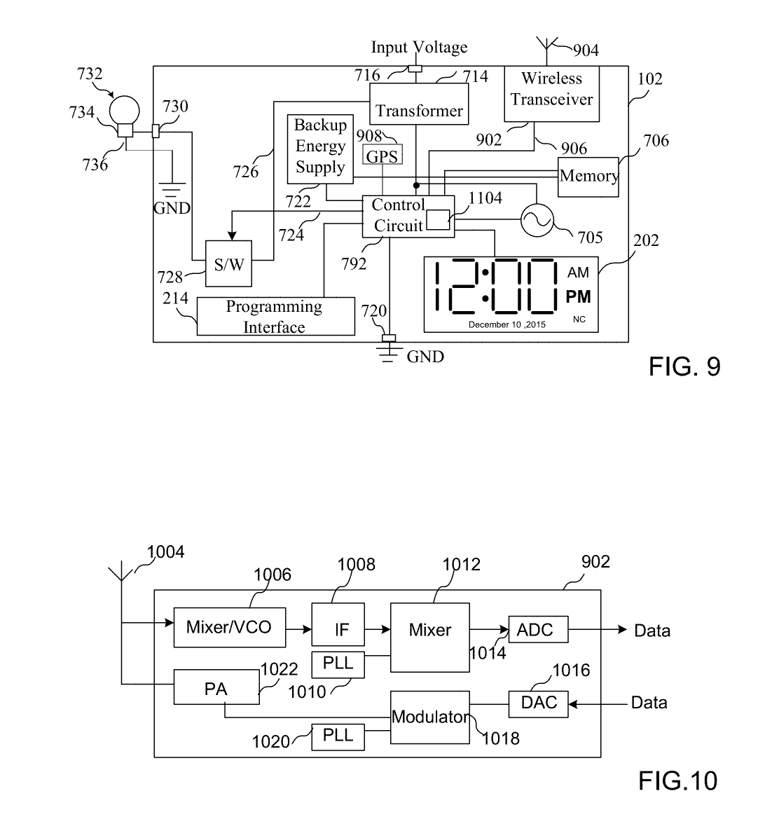

Turning first to FIG. 1, a perspective view of a front panel of an in-wall light timer having a cover according to an implementation of the present invention is shown. The timer of FIG. 1 comprises a housing portion 102 having an optional cover 104 (coupled to the timer by way of a hinge 106) which covers a user interface including a programming interface when in the closed position and enables programming the timer by way of the programming interface in the open position. A feedback indicator 108, such as a light and more particularly a light emitting diode (LED), could be implemented to show the status of the light or other appliance attached to the timer, for example. The feedback indicator could show green when a light attached to the timer is on, and could show red when the light is off. An optional switch 109 is movable between an on position, an off position, and a timer position for implementing the timer according to a selected timing pattern. While the cover is primarily cosmetic and may generally prevent unintentional changing of the timer, the timer cover is not necessary. Alternatively, the cover may be functional, such as functioning as an on/off override switch for the light or appliance attached to the timer in place of the switch 109. For example, the state of the light may be toggled (i.e. changed from a current state, such as on, to the other state, such as off) in response to pressing the cover which would activate a switch to change the state of the light if the switch 109 is not included, as will be described in more detail in reference to FIG. 2. Flanges 110 and 112, each having a threaded portion 114 for receiving a screw, are included to attach the timer to a junction box. While the various implementations are generally described in reference to a timer which is “hard wired” in a junction box and may be used for a porch light for example, it should be understood that the programming interfaces, circuits and methods set forth in more detail below could be implemented in a timer which is plugged into an outlet (commonly called an lamp or appliance timer), as will be described in more detail below in reference to FIG. 9. Further, while some examples are provided in terms of residential-type in-wall timers which are installed in a conventional residential junction box, it should be understood that the user interfaces, circuits and methods could be implemented in commercial timers or any other device requiring a timer.

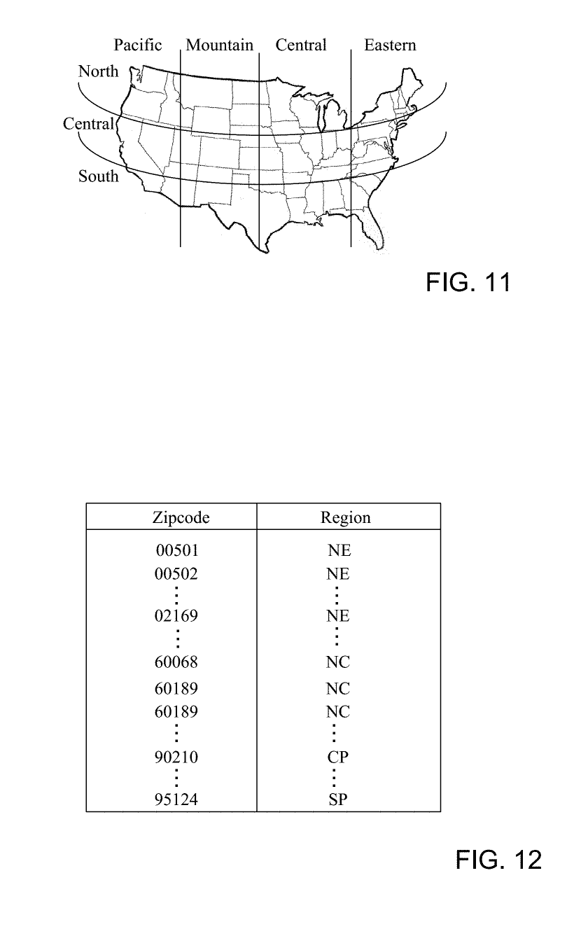

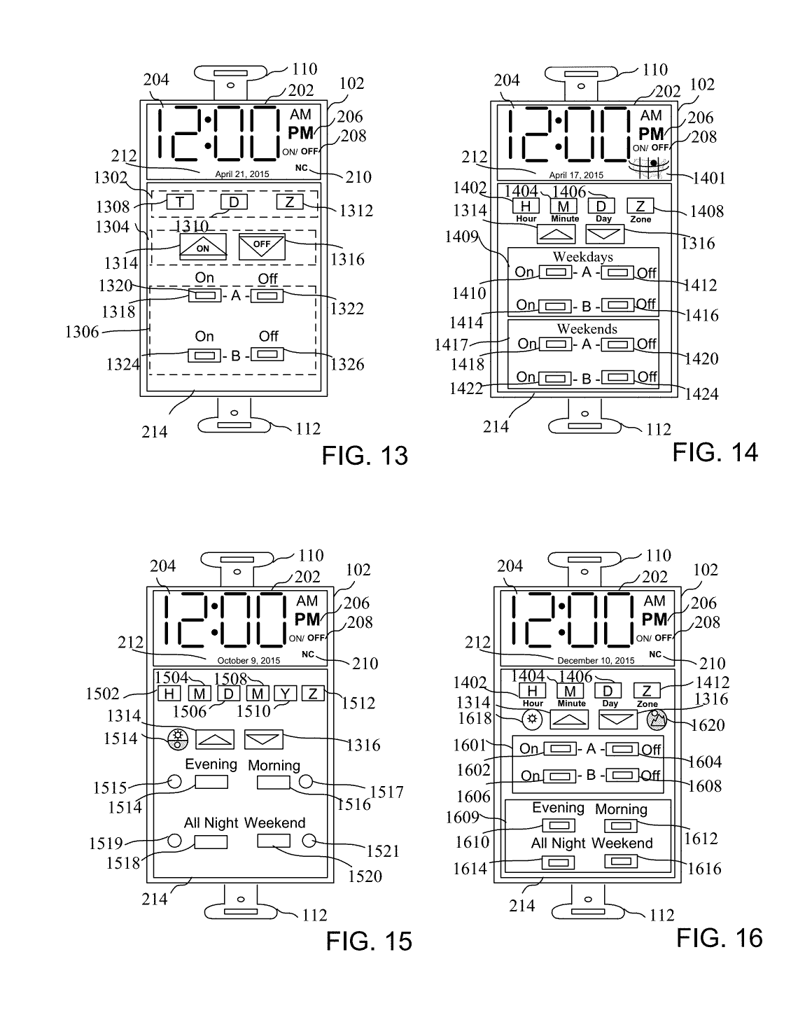

Turning now to FIG. 2, a perspective view of the front panel of the in-wall light timer of FIG. 1 with a cover open according to an implementation of the present invention is shown. As shown in FIG. 2, when the cover 104 is moved to an open position, a user interface comprises a display 202 having a plurality of information fields, including a current time field 204, an AM/PM field 206 that indicates whether the time displayed in the current time field is an AM time or a PM time, an on/off field 208 indicating whether a light or other appliance attached to the timer is on or off, a zone field 210 showing the geographical region, also known as a zone in which the timer is operating, and a date field 212. The selection and display of a zone in the zone field 210 in more detail in reference to FIGS. 11 and 12. The date field 212 preferably shows a day, month and year to enable the operation of the timer using astronomic times. A programming interface 214 having a plurality of actuators and programmable buttons enables programming the programmable buttons with on and off times including astronomic times. The programming interface 214 further comprises a toggle switch 216 that is controlled by a corresponding button 218, enabling manually turning on or off the light or other appliance attached to the timer using the cover 104. A connector, such as a USB port for receiving a USB memory device or other device such as a computer device (e.g. a laptop computer, tablet, or smart phone) to download data, including astronomic times associated with various zones that may be implemented by the timer. Various implementations of the programming interface will be described in more detail in reference to FIGS. 13-32.

As shown in the embodiment of FIG. 3, a perspective view of a front panel of an in-wall light timer having a cover and an exposed display and on/off actuator according to implementation of the present invention. As shown in FIG. 4, the cover 104 may be configured such that the on/off switch may be concealed when the cover is closed. Alternatively, the embodiment of FIG. 4 may be implemented with the toggle switch 216 and corresponding button 218, as described above in reference to FIG. 2.

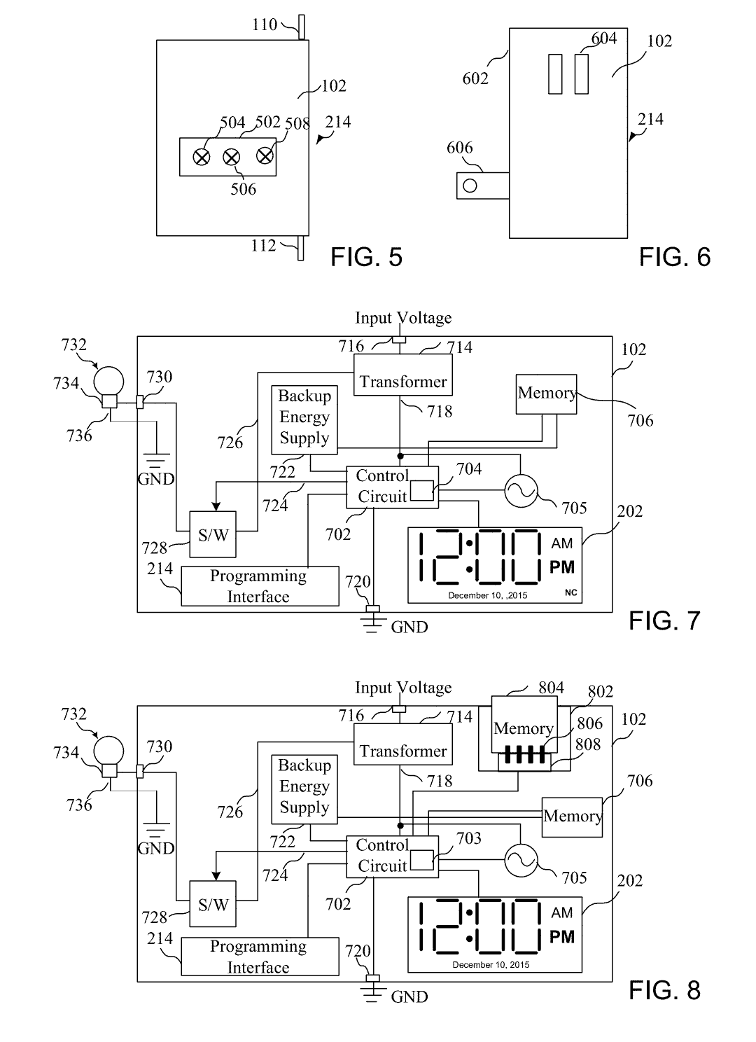

Turning now to FIG. 5, a side view of any of the timers of FIGS. 1-4 enabling the coupling of connectors on the timer to building wiring is shown. The side view of the timer shows a connector panel 502 having coupling elements 504-508, shown here as screws, for receiving wires of a junction box. Alternatively wires could extend from the timer and be connected to wires of the junction box.

Turning now to FIG. 6, a side view of a lamp timer that is configured to receive a plug and having electrical prongs that are configured to be plugged into a wall outlet is shown. Rather than a timer which is fixedly coupled to a junction box, the various programming interfaces and methods can be implemented in a timer adapted to be used with a wall outlet and adapted to receive a plug of a light or some other appliance. As shown in FIG. 6, the timer 602 comprises a receptacle 604 for receiving the prongs of a plug of a light or an appliance. The timer 602 also comprises prongs 606 to be inserted to an outlet to enable applying power to the light or appliance. The programming interface 214, shown opposite of the prongs 606, can be implemented according to any of the programming interfaces set forth above.

Turning now to FIG. 7, a block diagram of a circuit enabling the implementation of circuits and methods for operating a programmable light timer is shown. More particularly, a circuit for implementing a timer comprises a control circuit 702 adapted to access one or more of a plurality of pre-stored timing patterns. The control circuit 702 may be a processor having a cache memory 706 storing timing patterns and other data necessary to implement the timer. The memory 1006 may be implemented as a non-volatile memory, enabling the memory to store the timing patterns and data without loss due to a power loss, or retain data using a backup battery as described below. A transformer 714 is coupled to receive an input voltage at an input 716, and provide a regulator voltage signal 718 to various elements of the timers. A second input 720 is coupled to a ground terminal enabling a ground signal which is coupled various elements of the timer. A backup energy supply 722, which could be a battery or a capacitor for example, could be implemented to ensure that data of a memory is not lost during a loss of power. The control circuit provides a control signal by way of signal line 724 to a switch 728 which receives a regulated voltage by way of a line 726. The switch 728 controls the application of the regulated voltage to a voltage terminal 730 which enables power to be applied to an appliance 732, such as a light as shown. The appliance has a first terminal 734 for receiving the regulated voltage from the voltage terminal 730 and a second terminal 736 coupled to the ground potential. The programming interface 214 may implement any of the user interface and programming interface elements described in reference to FIGS. 1-7 and 13-32 is also shown.

Turning now to FIG. 8, a block diagram of a circuit enabling the implementation of circuits and methods for operating a programmable light timer having a slot for receiving a portable memory is shown. As shown in FIG. 8, a connector 802 of the timer, such as a USB connector, is implemented to receive a portable memory device, such as a USB memory device, and provide a connection to the control circuit 702. More particularly, contacts 806 of the portable memory device are coupled to corresponding contracts 808 of the connector. Various types of data or information can be provided to the control circuit or a memory of the timer, such as astronomic data, programming data, or firmware updates. Also, any type of portable memory device could be used, such as an SD memory.

Turning now to FIG. 9, a block diagram of a circuit enabling the implementation of circuits and methods for operating a programmable light timer using a wireless communication connection is shown. As shown in FIG. 9, a wireless communication circuit 702 is adapted to enable the wireless programming of certain data or information by way of a corresponding wireless communication circuit implemented in a computer device, such as a laptop computer, a tablet computer or a “smart phone.” An example of a wireless communication circuit is shown by way of example in FIG. 10. More particularly, a wireless transceiver 902 having an antenna 904 is coupled to the control circuit 702 by way of a communication bus 906. The wireless transceiver 902 could be used receive various information, such as astronomic data, programming data, or firmware updates. The implementation of FIG. 9 could further include a global positioning system (GPS) receiver 908 for receiving both geographic or location information related to the location of the timer and time data. The implementation of a GPS receiver would eliminate the need for a user to enter information related to the location of the timer or a current time for enabling operation of the timer. Therefore, control actuators for entering time and location information in the various implementations the programming interfaces set forth below could be eliminated with the use of a GPS receiver. A GPS receiver is commonly available from SiRF, for example. It should be noted that the implementation of FIG. 9 could also include the connector 802 for receiving the portable memory 804. Other types of communications circuits could be implemented, such as a Near Field Communication Circuit (NFC).

Turning now to FIG. 10, a block diagram of an exemplary wireless communication circuit enabling the operation of the wireless transceiver of FIG. 9 according to an implementation of the present invention is shown. In particular, the antenna 1004 receives wireless communication signals according to a predetermined wireless communication protocol. The data may be sent to the wireless transceiver 902 by way of a computer having or in communication with a corresponding wireless transceiver 902. The received data is coupled to a combined mixer/voltage controlled oscillator 1006, the output of which is coupled to an intermediate frequency (IF) circuit 1008. Based upon outputs of the IF circuit and a phase locked loop (PLL) 1010, a mixer 1012 generates the received data. An analog-to-digital converter (ADC) 1014 then generates digital data representing the timing characterization data.

The control circuit 792 may also provide data to the data transceiver for transmission to the computer. Data to be transmitted from the data transceiver 1002 is coupled to a digital-to-analog converter (DAC) 1016, the output of which is coupled to a modulator 1018 which is also coupled to a PLL 1020. A power amplifier receives the output of the modulator to drive the antenna 1004 and transmit the data. It should be noted that the wireless communication network could be configured to implement any wireless protocol for communicating with the wireless communication circuit of the timer of FIG. 10. According to one embodiment, the data transceiver could implement the IEEE Specification 802.11 wireless communication standard, the Bluetooth standard, an infrared protocol, or any other wireless data protocol. While the circuit of FIG. 10 is provided by way of example, other wireless data transceivers could be employed according to the present invention to implement the desired wireless communication standard.

Turning now to FIG. 11, a segmented map shows geographic regions of operation for a timer according to an implementation of the present invention. The geographic regions enable applying certain data, such a timing pattern having astronomic times, which is suitable for a timer implemented in the geographic area. As shown in FIG. 11, the geographic area of the continental US is divided into 12 regions identified by a longitudinal designation (shown here as the time zones) or latitudinal designation (shown here as 3 regions designated as north, central and south). According to the embodiment of FIG. 11, the regions are designated by a two letter code including the first letter of the longitudinal code followed by the first letter of the latitudinal code, by way of example. While 12 regions are shown by way of example, it should be understood that a greater number or fewer number of regions could be designated. Further, while geographic regions, other designation of regions could be implemented, such as zip codes or telephone area codes which could be provided by way of a portable memory device, a wireless communication connection, or a keypad described by way of example in FIG. 20.

Turning now to FIG. 12, a table having zip codes and corresponding regions is shown. By way of example in FIG. 12, the 12 regions designated in FIG. 11 could be associated with zip codes. Accordingly, when a user enters a zip code, data (such as astronomic times) associated with the region having the zip code would be used when implementing a selected timing pattern for the timer. By way of example, the data could be based upon a central location of the region, or an average of the different dusk and dawn times of the region. Alternatively, the average dusk and dawn times could be skewed toward more populated areas of the regions. Not only would average dusk and dawn times for the location be used based upon the zip code, but the correct time in the various time zones based upon the Greenwich Mean Time (GMT) would also be used. It should be noted that Daylight Savings Times (DST) could be implemented automatically based upon a selected region in which the timer is implemented.

Turning now to FIG. 13, a front plan view shows an actuator arrangement of a programmable light timer. While various implementations of a programming interface and a display are shown in FIGS. 13-20, it should be understand that particular features of the embodiments of FIGS. 13-20 could be implemented in any of the timer implementations of FIGS. 1-12. Further, in the various implementations, various actuators, including control actuators comprising field actuators and programming actuators for example, enable both programming field data, including for example current time, date and zone information as will be described in more detail below, and programming on and off times for programmable buttons.

In the implementation of FIG. 13, the programming interface 214 includes a first set of control actuators 1302 enabling the selection of one or more fields for allowing the selection of data associated with the one or more fields shown in the display (and used for implementing timing patterns). It should be noted that a timing pattern may comprise an on time and/or or off time for a particular time period (e.g. a day, group of days, every day, etc.) as will be described in more detail below. The programming interface 214 also includes a second set of control actuators 1304 comprising programming actuators that enable the programming of field data displayed in the display 202 or otherwise used by the timer for implementing timing patterns. The programming interface 214 further includes programmable buttons 1306 that can be pre-programmed or programmed to include to include on and off times (including astronomic times for on and off times) of the timer when selected, as will be described in more detail below. It should be noted that, while different implementations of the control actuators 1302 (enabling the selection of data for one or more fields) and programming actuators of the second set of control actuators 1304 (enabling the selection of data for the fields shown in the display or on and off times for the pre-programmed or programmable buttons) are shown in different embodiments, different implementations of the control actuators 1302 and the control actuators 1304 could be used together as desired. Further, different configurations of programmable buttons 1306 could be implemented, where the different configurations of programmable buttons 1306 could be implemented with selected control actuator arrangements for the control actuators 1302 and 1304. The various combinations of actuators of the control actuators 1302 and 1304 and the programmable buttons 1306 are shown by way of example to highlight different combinations of actuators and control buttons. However, it should be understood that other configurations of control actuators 1302 and 1304 and programmable buttons 1306 could be implemented.

According to the implementation of FIG. 13, the control actuators 1302 comprise field selection actuators, including a time button 1308 enabling the programming of a current time used by the timer, a date button 1310 enabling the programming of a current date, and a zone button 1312 enabling the selection of a geographical location or a zone associated with the operation of the timer. The control actuators 1302 could be used alone to enable the programming of data shown in the display and used by the timer to implement a timing program (i.e. field data associated with the time, date and location of the timer), or could be used in combination with control actuators 1304 to program data, as will be described in more detail below. That is, the control actuators 1302 are implemented to enable the selection of “field” data for enabling the timer to implement a timing pattern based upon the field data. The control actuators 1302 may be used alone, or in combination with other actuators to enable the selection of the data.

While the control actuators 1032 are shown and described by way of example below as buttons, it should be understood that the control actuators could be multi-function actuators for entering data associated with the actuator (i.e. time data associated with the time button, date data associated with the date button, and geographic data associated with the zone button). For example, actuators 1308-1312 could be rocker switches, where a flange extending from the actuator enables an upward motion to enable the forward (i.e. incrementing) change of data in the field, a downward motion to enable a backward (i.e. decrementing) change of data in the field, or an inward motion to enable the storing of the selected data. Such an operation could be similarly implemented by a dial, such as a Jog Dial™ actuator used in some Sony brand cellular telephones or video cameras. The actuators 1308-1312 could also be “button dials” commonly used in automotive radios for example. When the button (which may be flush with the surface of the timer) is pressed and released, it extends from the surface of the timer, and can be rotated to change (in a clockwise manner to increase or counter-clockwise manner to decrease) the data associated with the field. When the correct data is reached, the button can again be depressed to store the data, where the button is returned to its position that is flush with the front surface of the timer. Alternatively, the buttons 1308-1312 could be flush with the front surface of the timer, and could have a slot for enabling the selection of data displayed in the display 202 and used by the timer to be selected by rotating the button using a screw driver head in the slot of the button. Because the timer preferably has a backup battery and the data in the various fields should not changed or programmed often, such an arrangement for programming the data using a small screw driver would be beneficial in avoiding inadvertent changes to the data. While specific examples of the actuators 1308-1312 are shown, it should be understood that other actuators could be implemented. Further, the actuators 1308-1312 could enable the programming of the data using other actuators, such as actuators 1304, as will be described in more detail below.

The second set of actuators 1304 comprises a first control actuator 1314 enabling the increasing of a value associated with a data field shown on the display or used in the operation of the timer, and a second control actuator 1316 enabling the decreasing of a value associated with a data field shown on the display or used in the operation of the timer. The actuators of the second set of actuators 1304 can also enable different operations, including enabling programming programmable buttons or used in conjunction with the actuators of the set of actuators 1302 for programming data shown in the display during a programming of the timer, and enabling a function during the operation the timer. For example, control actuator 1314 can be used as an “on” button to override the timing operation of the timer and turn the light or appliance attached to the timer on, and control actuator 1316 can be used as an “off” button to override the timing operation of the timer and turn the light or appliance attached to the timer off. That is, the timer may be implemented such that the actuator 1314 may be function as an on button and actuator 1316 may function as an off button during normal operation of the timer, but would function as programming actuators to increase or decrease programming values after one of the actuators 1302 is selected to enable the programming of data shown in the display, for example, or one of the programmable buttons of the programmable buttons 1306 is selected to be programmed. Examples of programming data show on the display using the actuators 1302 and the actuators 1314 and 1316 in a programming operation, as well as using the actuators 1314 and 1316 for programming the programmable buttons, will also be described below.

The programmable buttons 1306 comprise a plurality of buttons that can be programmed with one or more on or off times. As will be described in more detail below, a programmable timer can be pre-programmed by the manufacturer of the timer, be pre-programmed with one of the on and off time associated with the button and programmable to select the other of the on and off times or be programmable for both on and off times. That is, particular programmable button may have only one of an on time or an off time associated with the button, where the one on or off time is programmable by the user, or may have both on and off times that are programmable by a user of the timer.

Although the actuators 1314 and 1316 are shown as separate buttons, it should be noted that the two actuators 1314 and 1316 could be implemented as a part of a single actuator, such as a rocker switch, or any of the types of actuators described above in reference to the control actuators 1302. As shown in the implementation of FIG. 13, two sets of programmable buttons (designated at set A and Set B) are provided, where one button of each set is programmed with an on time and the other programmed with an off time. More particularly, programmable buttons 1306 comprises a first programmable button 1318 representing an on button for the timing pattern A and having a status indicator 1320 (shown here as an LED that is on when the button is selected). The programmable buttons 1306 also comprises a programmable button 1320 representing an off button for the timing pattern A and also having a status indicator (also shown here as an LED that is on when the button is selected). As will be described in more detail below, the buttons 1318 and 1322 are programmable to have only a single time (including the option of dusk or dawn for the selected zone) as being the selected time for turning the light on or off, respectively. A second set of on and off buttons comprising on button 1324 and off button 1326 associated with timing pattern B for the timer. According to on practical implementation of the arrangement of FIG. 13, timing pattern A could be set for operation during the evening hours (e.g. turn on at dusk and turn off at midnight) and timing pattern B could be set for operation during the morning hours (e.g. turn on at 5 AM and turn off at dawn). Alternatively, a timing manufacturer could configure the implementation of FIG. 13 to enable a single timing pattern in a given day, where timing pattern A relates to weekdays, and timing pattern B relates to weekends.

According to another feature of the programmable interface, other programming operations of the timer can be associated with an individual button. For example, stored timing parameters associated with an individual button can be reset by selecting the button for a predetermined period of time (e.g. 10 seconds). That is, rather than having to reset all of the stored data associated with implementing the timer, data with specific programmable buttons can be individually reset. All of the data for the timer can be reset by selecting both of the actuators 1314 and 1316, for example, for a predetermined period of time. Therefore, by eliminating a menu-based programming operation of conventional devices, and enabling a dedicated programming operation associated with individual buttons, a simple and intuitive programming method that users can implement without the aid of a user manual can be provided. Further, changing one on or off time associated with the timer can be easily achieved by changing a timing parameter associated with a single button, eliminating the need to advance through a menu associated with all features of the timer to reprogram a specific timing parameter, or be forced to reprogram the entire timer.

Turning now to FIG. 14, a front plan view shows an actuator arrangement of a programmable light timer having additional time actuators and having weekday and weekend programmable buttons. While different features provided in the implementation of FIG. 14 will be described, it should be understood that any of individual feature of these different features could be implemented in any of the other implementations of FIGS. 13 and 15-20. That is, as with all of the implementations of FIGS. 13-20, the various arrangements of actuators in the sets of control actuators 1302 and 1304 can be interchanged, and the various arrangements of programmable buttons 1308 can be interchanged. The selection of control actuators and programmable button in a given implementation is provided to show different levels of operations and features of a timer, and it is contemplated that any particular feature could be implemented in any of the programming interfaces or displays.

In the implementation of FIG. 14, the set of actuators 1302 comprises separate hour and minute buttons for programming the time. The set of control actuators 1302 of FIG. 14 comprises an hour actuator 1402, a minute actuator 1404, a day actuator 1406 and a zone actuator 1408. The programming buttons 1306 also includes four different sets of programmable on and off buttons, including two sets of on and off buttons for weekdays and two set of on and off buttons for weekends. More particularly, a first set 1409 of on and off buttons comprises a first on button 1410 associated with an on time and a first off button 1412 for a first set A to be applied during weekdays, and a second set 1417 of on and off buttons comprises a first button 1414 associated with an on time and a second off button 1416 for a second set B to be applied during weekdays.

Similarly, a first set of on and off buttons comprises a first on button 1418 associated with an on time and a first off button 1420 for a first set A to be applied during weekends, and a second set of on and off buttons comprises a first button 1422 associated with an on time and a second off button 1424 for a second set B to be applied during weekends. As will be described in more detail below, a dusk or dawn times associated with the selected zone could be selected as on and off times by selecting the hour button, and using the control actuators 1314 and 1316 to advance through available hours and options for selecting dusk or dawn. The programming and operation of the two sets of programmable buttons for weekday and weekend buttons each could be implemented as described in reference to the two sets of buttons A and B in FIG. 13. However, if no data is entered for weekends, the timing patterns for weekends could be applied every day of the week. It should be noted that the implementation of FIG. 14 could be implemented with a single set of programmable buttons (i.e. programmable buttons 1410-1416)

Also shown in FIG. 14 is another way of displaying a current zone that may be selected by a user as described below. While the alphabetic representation of a zone (e.g. NC for a North and Central region) provides an intuitive representation of a zone, the graphical representation 1401 (which is the segmented map of FIG. 11, with one of the segments marked to show the location of the timer) provides a user with a clear indication of the geographical area (such as the North Central region of the United States) in which the timer is operating. The region shown in the geographical representation 1401 could be provided by GPS coordinates from a GPS receiver of the timer, or selected on the user interface using the Zond button.

Turning now to FIG. 15, a front plan view shows an actuator arrangement of a programmable light timer having an astronomic selection button and additional actuators for selecting a day of a year. The set of control actuators 1302 includes separate day, month and year actuators. More particularly, in addition to an hour actuator 1502, a minute actuator 1504, and a zone actuator 1512, the control actuators 1302 include a day (D) actuator 1506, a month (M) actuator 1508, and a year (Y) actuator 1510. According to the implementation of FIG. 15, the day, month and year data displayed on the display (and used in implementing timing patterns used by the timer) can be selected by the corresponding button. For example, a day of the month between 1 and 31 can be selected by selecting the day button and using the control actuators 1314 and 1316 to advance through the possible 31 calendar days, as will be described in more detail below. The implementation of FIG. 15 further includes a dedicated actuator for selecting dusk or dawn as an on time or off time when programming a programmable button, rather than selecting (or in addition to being able to select) dusk or dawn by using the actuators 1316 and 1316 as described in reference to FIG. 14. More particularly, a dusk/dawn actuator 1514 enables toggling between dusk, dawn and a time as a programmable on time or off time. As will be described below, when a programmable button is selected to be programmed, a time for an on time or an off time for a timing pattern will be displayed. A user can then cursor through the hour (i.e. 1-12 displayed twice with either an AM or PM designation) to select a specific time for an on time or off time for the timing pattern applied when the programmable button is selected. However, if the user would prefer to have dusk or dawn selected as the on time or off time that is currently being programmed for the programmable button, the user would select the dusk/dawn actuator 1514, which would then display “DAWN” on the display. A user could select dawn as the on or off time by again selecting the programmable button to store dawn as the on or off time associated with the button and used while implementing a timing pattern when the button is selected to be used during normal operation of the timer (i.e. after programming the button). If the dusk/dawn actuator 1514 were selected again (rather than selecting the programmable button to store dawn as the on time), “DUSK” would appear in the display, enabling a user to select dusk as the on or off time as the on or off time associated with the button and used while implementing a timing pattern when the button is selected to be used during normal operation. If the user did not desire dusk or dawn as the on or off time, the user could select the dusk/dawn actuator 1514 again to return to an hour (in the hour field on the display), enabling the user to select a time for an on or off time for the timing pattern for the timer.

The programmable buttons 1306 of FIG. 15 comprises a first programmable button 1514 having a corresponding status indicator 1515 (shown here as an LED). The first programmable button 1514 corresponds to an evening time operation. That is, the user programs the programmable button for an evening time operation, enabling a user to select the evening button when evening times are desirable by the user. The second button 1516, having a corresponding status indicator 1515, is programmed by the user for morning times, enabling a user to program desirable times for morning hours. The third button 1518, having a corresponding status indicator 1519, is programmed by the user for “all night” operation, enabling a user to program desirable times from evening to morning (i.e. dusk to dawn, 9:00 PM to dawn, dusk to 5:00 AM etc.). The fourth button 1520, having a corresponding status indicator 1521, is programmed by the user for weekend hours times, enabling a user to program desirable times for weekend hours. Weekend hours could be associated with any time of the day, and particularly selected for weekends. For example, desired evening hours for weekends (e.g. Friday and Saturday evenings) could be programmed to be on later than “weekday” nights of the week. Therefore, when the weekend button is selected, different hours will be applied on days of the weekend during a time that may correspond to another button that has been selected. The programmable buttons of FIG. 15 can also be programmed to include dusk or dawn as an on time or an off time, as will be described in more detail below.

Turning now to FIG. 16, a front plan view shows an actuator arrangement of a programmable light timer having programmable on and off times (such as in FIG. 13), and on and off times associated with particular time periods of a day (such as in FIG. 15). According to the implementation of FIG. 16, the programmable buttons include a first type of programmable button 1601, including a first set of on and off buttons 1602 and 1604 and a second set of on and off buttons 1606 and 1608. The buttons of the first type of on and off buttons are programmable for a single on or off time, as described for example in reference to FIG. 13. The programmable buttons also include a second type of programmable buttons 1609, including a first button 1610 associated with evening times, a second button 1612 associated with morning times, a third button 1614 associated with an “all night” timing program, and a fourth button 1616 associated with weekend times. The buttons of the second type of on and off buttons are programmable for both on and off times, as described in reference to FIG. 15.

As further shown in FIG. 16, a separate dawn button 1618 and dusk button 1620 are included. Rather than selecting dusk or dawn from a single dusk/dawn button 1514, dusk or dawn could be selected by the individual, dedicated buttons. During programming, each of the buttons could enable returning to programming specific times by selecting the button again, as described in FIG. 15, where the button would allow the user to toggle between a dusk or dawn setting, respectively, and a time setting. Alternatively, a user could avoid storing the selected dusk or dawn time by not pressing the programmable button within a predetermined period of time (i.e. a timeout), causing the programming to return to the time entry or simply be ended (and therefore requiring the user to again select the button to be programmed).

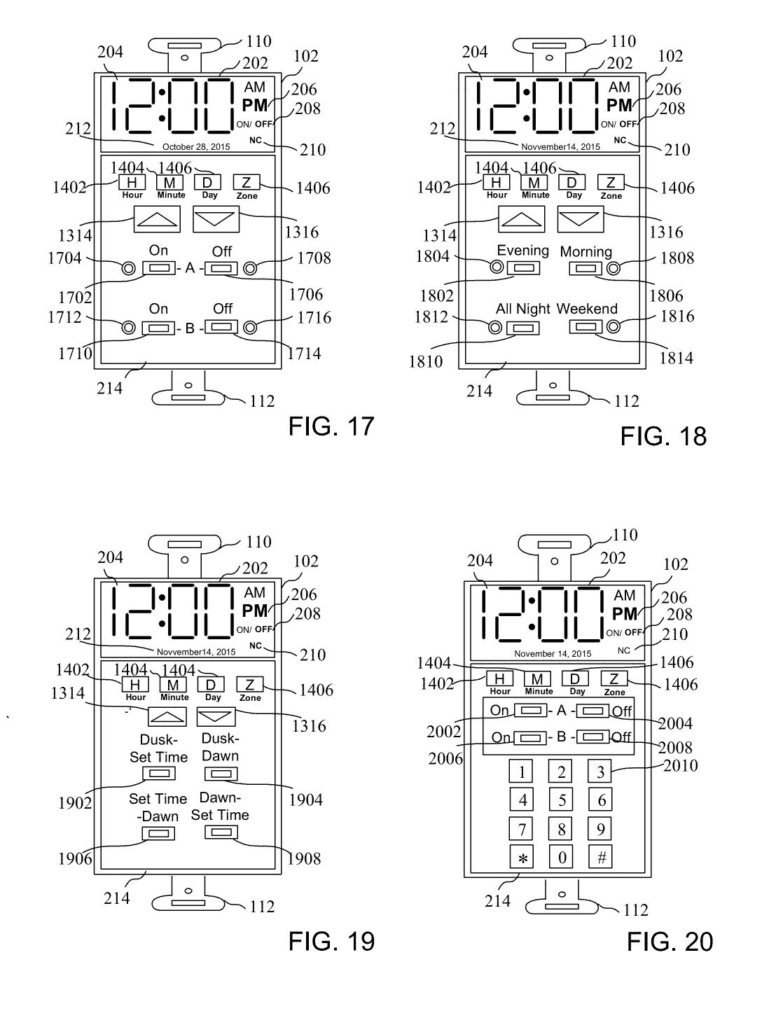

Turning now to FIGS. 17 and 18, implementations are shown where the programmable buttons have a dedicated dusk/dawn buttons for programming dusk or dawn as an on time or an off time for a corresponding programmable button. More particularly, FIG. 17 comprises a programmable button 1702 associated with an on time for a set A having a corresponding dedicated dusk/dawn button 1704, a programmable button 1706 associated with an off time for a set A having a corresponding dedicated dusk/dawn button 1708, a programmable button 1710 associated with an on time for a set B having a corresponding dedicated dusk/dawn button 1712, and a programmable button 1714 associated with an off time for a set B having a corresponding dedicated dusk/dawn button 1716.

Similarly, FIG. 18 comprises a programmable button 1802 associated with evening hours having a corresponding dedicated dusk/dawn button 1804, a programmable button 1806 associated with morning hours having a corresponding dedicated dusk/dawn button 1808, a programmable button 1810 associated with an “all night” program having a corresponding dedicated dusk/dawn button 1812, and a programmable button 1814 associated with weekend hours for a set B having a corresponding dedicated dusk/dawn button 1816.

Turning now to FIG. 19, a front plan view shows an actuator arrangement of a programmable light timer having programmable buttons associated with predetermined times of the day including dusk or dawn as an on or off time for the user programmable button. That is, dusk or dawn may be a preset on or off time, and the user would only have to set the other of the on or off time. A programmable button 1902 is programmable to provide a timing pattern from dusk (as an on time) to a set time programmed by a user (as an off time), where the user only needs to set the off time. For example, programmable button 1902 could be selecting as a timing pattern by setting an off time of 11:00 PM, where a timing pattern of dusk to 11:00 PM would be used if the programmable button were selected. A dedicated dusk-to-dawn button 1904 could also be implemented, where the light or other appliance controlled by the timer would turn on between dusk and dawn. A set time-dawn button 1906 could also be implemented, where a user would program the on time to enable a timing pattern to turn on a light or appliance between some time (selected by a user) before dawn and dawn. Finally, a dawn-set time button 1908 could be selected, where a user would select the set time to turn the light or other appliance off after being turned on at dawn, for indoor applications for example.

Turning now to FIG. 20, a front plan view shows an actuator arrangement of a programmable light timer having a numeric keypad for enabling the selection of on and off times and the selection of dusk or dawn times as on or off times. The timer of FIG. 20 could include any types of programmable buttons, shown here to include dedicated on and off buttons 2002 and 2004 associated with a set A and on and off buttons 2006 and 2008 associated with a set B by way of example, as described above in reference to FIG. 13. However, it should be understood that any other arrangement of programmable buttons could be implemented.

A keypad 2010 enables the programming of any field implemented in the display (and therefore used for implementing a timing pattern), or programming an on or off time associated with a programmable button. For example, when programming an hour for the current time in the display, the hour button could be selected (such as by depressing the hour button for a predetermined period of time), and then entering an hour (i.e.12) on the keypad. The hour can be selected based upon military time (i.e. 1-24 hours) to enable the selection of AM and PM. The selected hour can then be stored by depressing the hour button again. The minutes could be similarly selected and stored. The day could be selected based upon a “mm/dd/yyyy” format, for example, where June 13, 2015 would be selected as “06132015”. The zone could be designated by number, where a given zone as described above could be selected by entering the corresponding number. Alternatively, a zip code could be entered to select a zone. During a programming of an on or off time associated with a button (as will be described in more detail below), a time associated with the on time or off time shown on the screen could be selected using military time. The star (*) key could be selected for dawn as an on time or off time (depending upon whether an on time or off time for the button is being programmed), and the pound (#) key could be selected for dusk for the on time or off time.

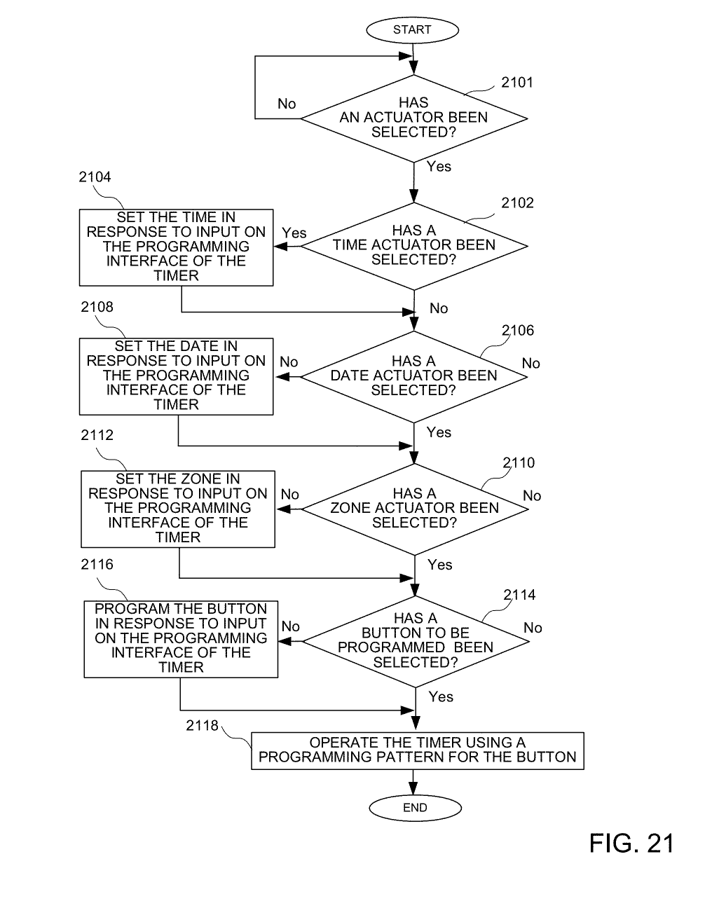

Turning now to FIG. 21, a flow chart shows a method of enabling the entry of time/date information, geographic data, and programming data, according to any of the programming interfaces set forth above in reference to FIGS. 13-20. In particular, it is determined whether an actuator is selected at a block 2101. The timer will then display an appropriate response for a user to program data in the display or an on or off time for a programmable button. More particularly, It is determined if a time actuator is selected at a block 2102. If so, a time is set in response to input on the programming interface of the timer at a block 2104. For example, the time (T) button, hour (H) button or minute (M) button could be selected to enable selecting a time for a current time displayed on the display and used in the implementation of a timing pattern. One of the time (T) button, hour (H) button or minute (M) button could be depressed for a period of time (e.g. 5 seconds) to enable changing the time. The control actuators 1302, and more particularly the actuators 1314 and 1316, enable cursoring up or down for incrementing or decrementing the time (or individually for hours and minutes if separate hour and minute buttons are provided). The desired value when reached after the cursoring operation can then be selected by depressing the previously selected time, hour or minute button again (such as for a predetermined period of time of 5 seconds for example).

If not or after enabling the entry of a time, it is determined whether a date actuator has been selected at a block 2106. If so, a date is set in response to input on the programming interface of the timer at a block 2106. For example, the date (D for Date as shown in FIG. 13) or one of the day (D), month (M) or year (Y) buttons (as shown in FIG. 15) could be selected to enable selecting a current date displayed on the display and used in the implementation of a timing pattern. The selected button could be depressed for a predetermined period of time (e.g. 5 seconds) to enable changing the date or a component of the date. The control actuators 1314 and 1316 could be used to enable cursoring up or down to select the correct date. The desired value when reached after the cursoring operation can then be selected by depressing the previously selected button associated with the date again (such as for a predetermined period of time of 5 seconds for example).

If not or after enabling the entry of a date, it is determined whether a zone actuator has been selected at a block 2110. The zone actuator could be depressed for a predetermined period of time, and the actuators 1314 and 1316 could be used to cursor through available geographic zones that could be selected to enable the use of astronomic times for on and/or off times. Alternatively, a current time and zone may be provided by a GPS receiver implemented in the timer, as described above.

If not or after enabling the entry of a zone, it is determined whether a programmable button has been selected at a block 2114, where the programmable button is then programmed at a block 2118 using the programming interface to implement a timing pattern for the button, as will be described in various implementations below.

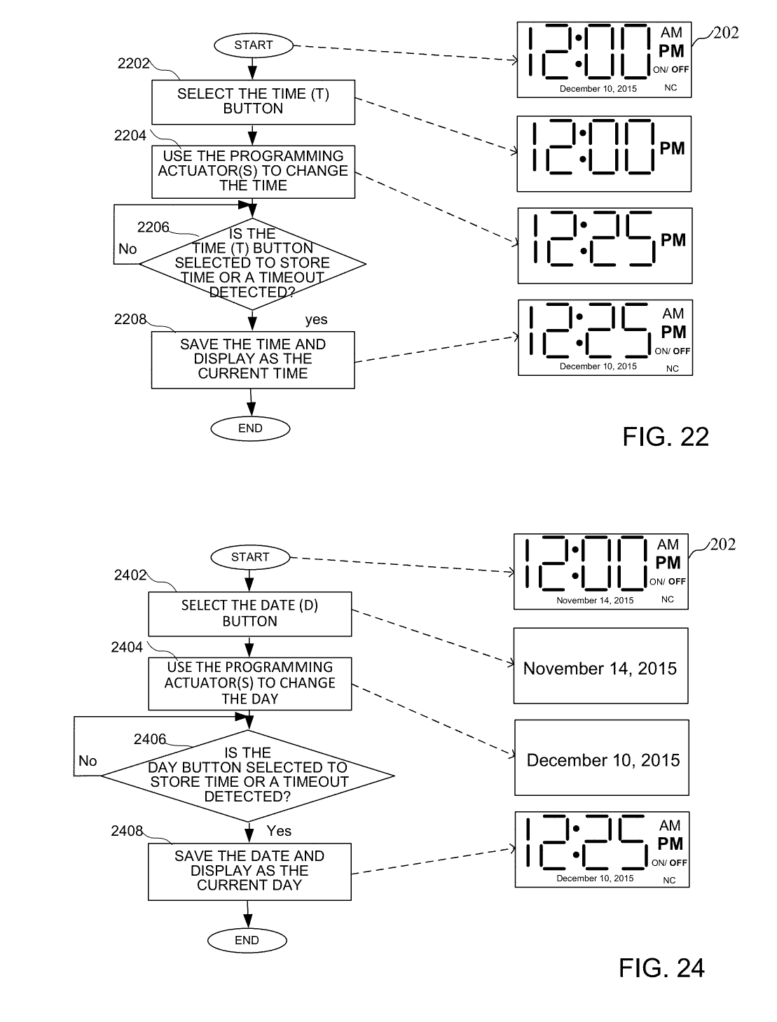

Turning now to FIG. 22, a flow chart shows a method of entering a current time for the timer using actuators of a programming interface of the timer. More particularly, after a time button (T) is selected at a block 2202 and a number is selected by use of the actuators 1314 and 1316 at a block 2204, it is determined whether the time button is again selected or a timeout has been reached at 2206. If so, the time is saved and stored as a current time at a block 2208. The display 202 shows the time field changing throughout the programming operation to change the time from 12:00 PM to 12:25 PM. It should be noted that the programming operation of an on or off time for a programmable button would be performed in a similar manner, as will be described in more detail below in reference to programming a programmable button having both a programmable on time and programmable off time.

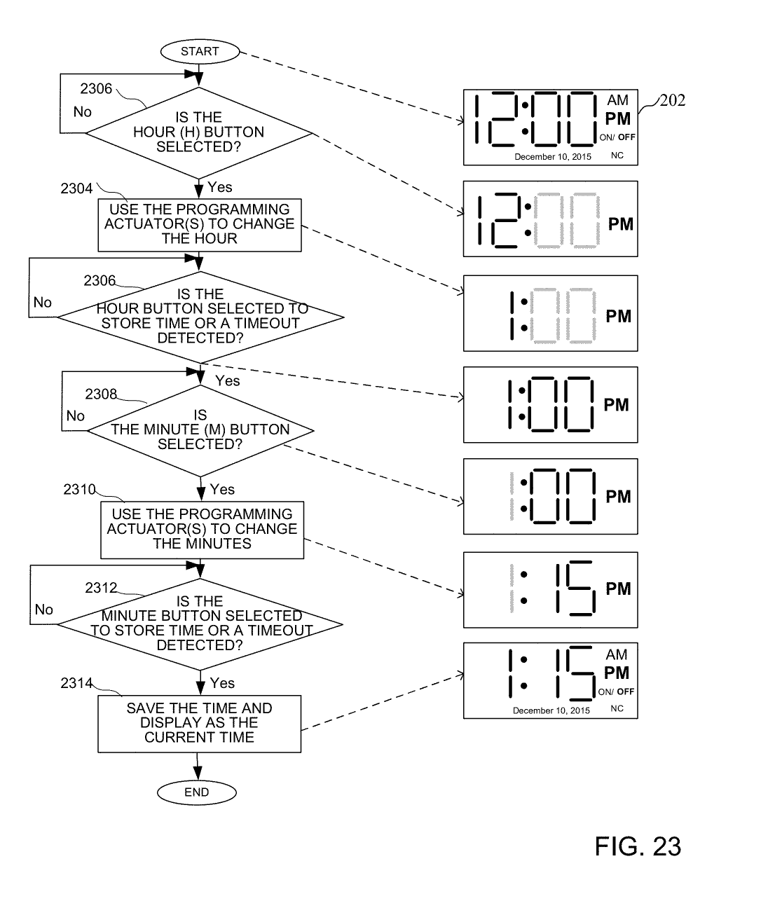

Turning now to FIG. 23, a flow chart shows a method of entering a current time for the timer using separate hour and minute actuators of a programming interface of the timer. In particular, after the hour (H) button is selected at a block 2302 and a number is selected by use of the actuators 1314 and 1316 at a block 2304, it is determined whether the hour button is again selected or a timeout has been reached at 2306. As shown in the displays next to the flow chart, the hour for the current time is changed from 12 PM to 1 PM, where only the hour digits are shown, and the remaining digits of the time may be displayed in phantom (as shown) or not at all. It should be noted that an AM hour could be selected by continuing to cursor through the hours until AM is shown with hour digit(s).

Further, it is determined whether the minute (M) button is then selected at a block 2308 and a number is selected by use of the actuators 1314 and 1316 at a block 2310, it is determined whether the minute button is again selected or a timeout has been reached at 2312. If so, the time is saved and stored as a current time at a block 2314. As shown, the minutes are changed from 00 to 15 (where the previously programmed hour digits are shown in phantom), leading to a final stored current time of 1:15 PM.

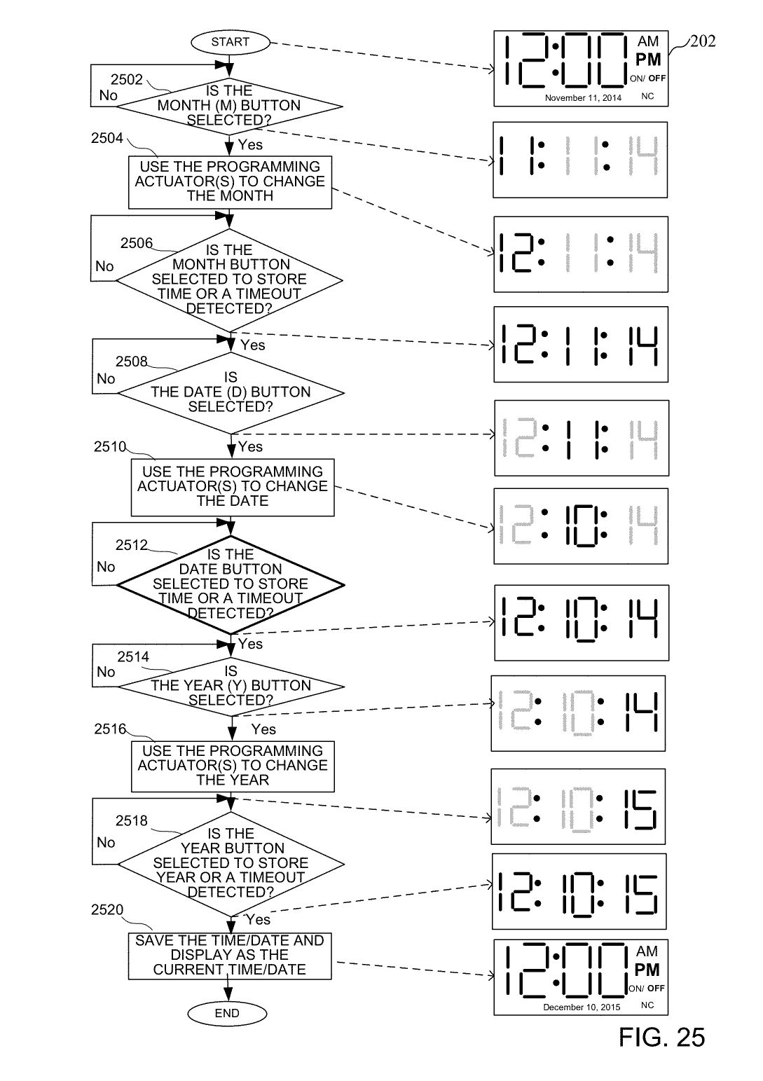

Turning now to FIG. 24, a flow chart shows a method of entering a current day for the timer using actuators of the programming interface of the timer. More particularly, after a date button (D) is selected at a block 2402 and a date is selected by use of the actuators 1314 and 1316 at a block 2404, it is determined whether the time button is again selected or a timeout has been reached at 2406. If so, the time is saved and stored as a current time at a block 2408. The display 202 shows the time field changing throughout the programming operation to change the date from November 14, 2015 to December 10, 2015. While the date can be programmed using a single actuator (D for date) as shown in FIG. 13, the date can be more easily programmed using multiple actuators, as described in reference to FIG. 25.

Turning now to FIG. 25, a flow chart shows a method of entering a current date for the timer using separate month, day, and year actuators of the programming interface of the timer. It is first determined whether the month (M) button is selected at a block 2502. If so, the programming actuators are used to change the month at a block 2504. The date may be shown on the display during programming as two digit fields associated with twelve days, thirty-one months or 100 years (0-99 for the 21st century). The month is changed from 11 to 12, as shown. It is then determined whether the month button is selected or a timeout has been detected at a block 2506. It should be noted that unless the button is selected before a timeout is detected, any new data for a field will not be stored, and the programming operation will end. Alternatively, new data can be stored when the button is selected or a timeout is detected. If programming for a given portion of a date is ended and no additional information is added, the programming will be ended after a second timeout.

It is then determined whether the day (D) button is selected at a block 2508. If so, the programming actuators are used to change the day of the month at a block 2510. The day is shown changed from day 11 to day 10 of December. It is then determined whether the day button is selected or a timeout has been detected at a block 2512 to store the day or end programming as described above.

It is first determined whether the year (Y) button is selected at a block 2514. If so, the programming actuators are used to change the year at a block 2516. The year is shown changed from 14 to 15 (i.e. 2014 to 2015). It is then determined whether the year button is selected or a timeout has been detected at a block 2518 to store the year or end programming as described above, where the time is saved and displayed as the current time at a block 2520.

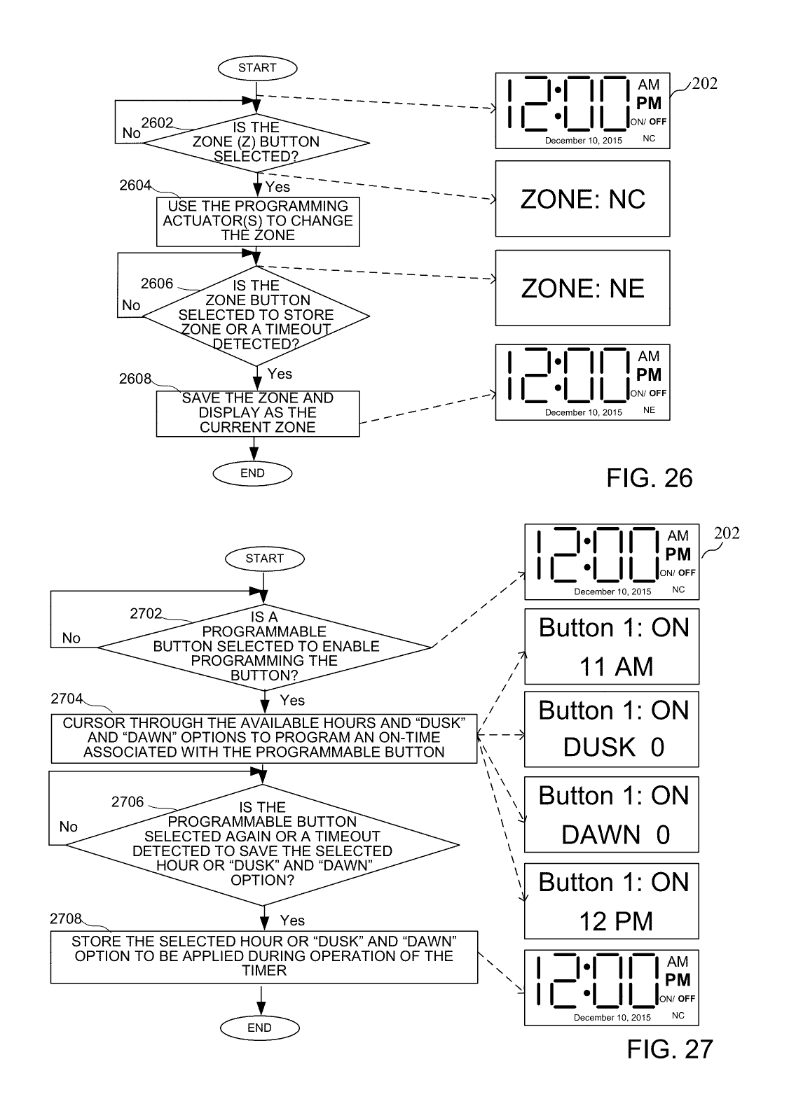

Turning now to FIG. 26, a flow chart shows a method of selecting a geographic location, also known as a zone, in which the timer is operating. In particular, it is determined whether the zone (Z) button is selected at a block 2602. If so, the programming actuators are used to change the zone, shown here as being changed from NC (North Central, covering Chicago for example) to NE (North East covering Boston for example). It is then determined whether the zone button is again selected at a block 2606 to store the selected zone. If so, the zone is saved and displayed as the current zone at a block 2608. If the zone is changed based upon the programming and storing protocol, the display will then show NE as the zone in which the timer is operating, and therefore the dusk and dawn times for that zone are applied with certain timing patterns that rely on dusk and dawn times are selected.

Various implementations for programming a programmable button, and more particularly programming a programmable button that enables dusk or dawn to be used as an on or off time, will now be described. Turning first to FIG. 27, a flow chart shows enabling programming a programmable button (having a single programmable time) for turning on or off at dusk or dawn using an actuator of the programming interface. It is first determined whether the programmable button is selected to enable programming the button at a block 2702. For example, the programmable button could be depressed and held for a predetermined period of time. The user could then use actuators to cursor though possible programmable times (depending upon whether the single programmable time is associated with an on time or an off time for a given button according to the various examples of FIGS. 13-20 for example) at a block 2704.

According to one embodiment having an hour (H) button for selecting an hour, a user may cursor through available hours associated with an on or off time being programmed. During the cursoring, a user will have 26 available options. That is, in addition to the available times of 11 and 12, a DUSK option and a DAWN option is provided. According to the example sequence shown with the flow chart, a button 1 (which is associated with an on time) can be programmed for DUSK or DAWN by passing through 11 AM and before reaching 12 PM, where the user will be able to select DUSK as a first option after 11 AM or DAWN as a second option after 11 AM. If the user were to select neither DUSK nor DAWN, the user could continue to cursor through times after 12:00 PM, or return to select DUSK or DAWN. While a user could more easily select DUSK or DAWN associated with a separate hour (H) button, a user could be able to select DUSK as a first option after 11:59 AM or DAWN as a second option after 11:59 AM and before 12:00 PM. That is, if the time (T) button were selected in an embodiment not having separate hour and minute buttons, a user could pass 11:59 AM using the control actuators, and have the option of selecting DUSK and the DAWN before having the option of selecting 12:00 PM. It should be noted that the “0” after DUSK and DAWN represents a zero “offset” as will be described in more detail below, where a user can use the actuator keys to select an offset representing a time before or after dusk or dawn when the timer is turned on. If the button is again selected or a timeout is detected at a block 2706, the selected hour or dusk or dawn is stored at a block 2708.

It should be noted that individual days or groups of days can be programmed according to various implementations. For example, when a programmable button is first selected for the predetermined period of time, a day or set of days is shown. For example, MON-SUN may be shown on the display. If the user desires to have the timing pattern that is being programed include Monday through Sunday, the user will again select the programmable button for the predetermined period of time to enable Monday through Sunday to be programmed. Otherwise, the user can then depress the button again (e.g. a normal selection of the button, but less than 5 seconds) to program a timing pattern for a different day or set of days. Another selection of the button for less than the predetermined period will display a third day or group of days to be programmed. By way of example, days or groups of days which can be selected to be programmed for the programmable button can include MON-SUN→WEEKDAYS→WEEKENDS→MON→TUE→WED→THU→FRI→MON/WED/FRI→TUE/THU→SAT/SUN. It should be noted that a programmable button could be program twice. For example, a first programming would include WEEKDAYS and a second programming would include WEEKENDS. If multiple programming patterns overlap, a collision avoidance technique could be implemented, such as a later programmed timing pattern would be implemented in the event of a timing conflict.

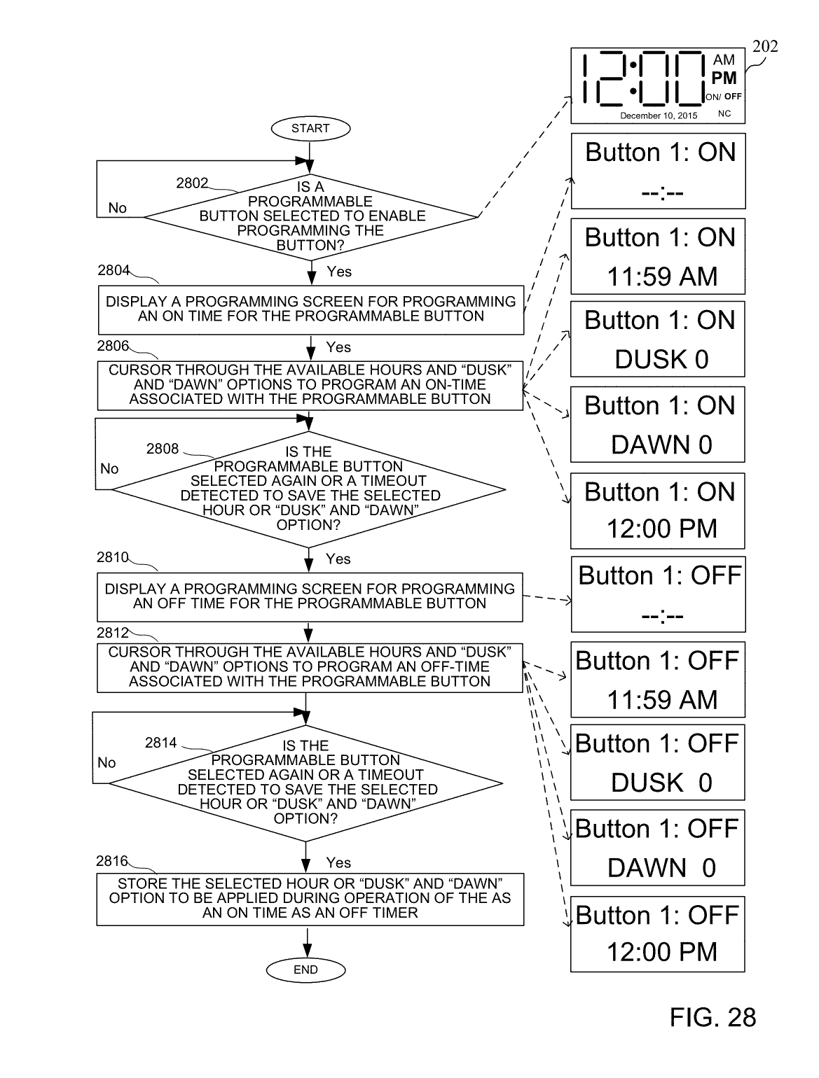

Turning now to FIG. 28, a flow chart shows enabling programming a programmable button for both turning a light on and off, including at least one of dusk or dawn, using an actuator of the programming interface. The implementation of FIG. 28 is similar to the implementation of FIG. 27, but where a second time (e.g. off time) is programmed after the first time (e.g. off time) is programmed. It is first determined whether the programmable button is selected to enable programming the button at a block 2802. For example, the programmable button could be depressed and held for a predetermined period of time. A programming screen for programming an on time for a programmable button is then displayed at a block 2804. The user could then use actuators to cursor though possible programmable times (depending upon whether the single programmable time is associated with an on time or an off time for a given button according to the various examples of FIGS. 13-20 for example) at a block 2806. If the button is again selected or a timeout is detected at a block 2808, the selected hour or selected dusk or dawn option is stored and a program screen for programming an off time for the programmable button is displayed at a block 2810.

A user can then cursor through the available hours and the dusk and dawn options to program the off time associated with the programmable button at the block 2812. It is then determined whether the programmable button is selected again or a timeout is detected to store the time or dusk or dawn option at a block 2814. If the programmable button or the timeout is detected, the selected off time is stored at a step 2816. As described above in reference to FIG. 27, a user could pass through DUSK and DAWN options to enable the selection of those times for turning a light on or off. Further, the dusk and dawn options are shown in FIG. 28 with respect to a time (T) actuator, the dusk or dawn option could also be selected with an hour (H) actuator. While the DUSK and DAWN options are shown by way of convenience as between 11:59 AM (or the 11 hour when implemented with an hour button) and 12:00 PM (or the 12 hour when implemented with an hour button), it should be understood that DUSK could be placed closer to an average dusk (e.g. 6 PM), while DAWN could be placed closer to an average dawn (e.g. 6 AM) to provide more intuitive programming.

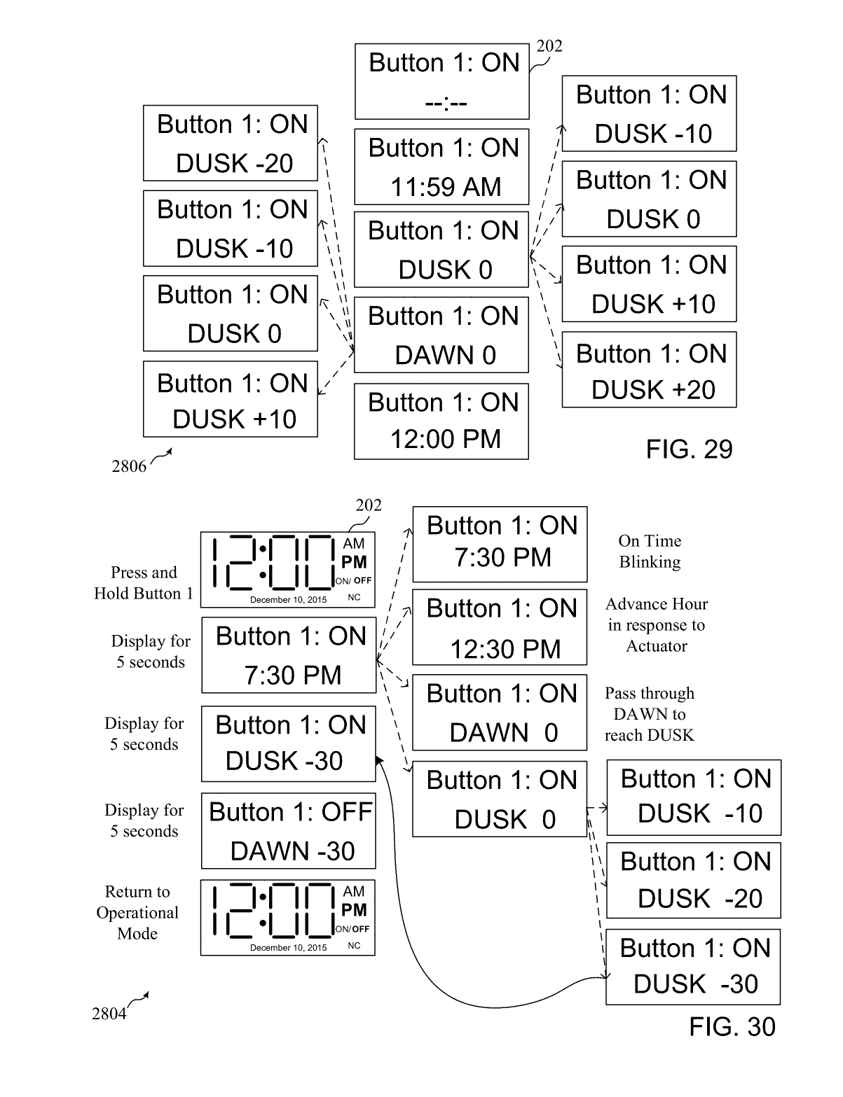

Turning now to FIG. 29, a sequence, shown on a display of a programmable light timer, during the selection of a dusk or dawn time associated with the operation of programming buttons is shown. As shown in FIG. 29, when a programmable button is first selected for programming, dashed lines for the hour and minute fields are displayed. As the user passes through 11:59 AM to the DUSK option by using the actuators 1314 and 1316, a user has the option of selecting an offset from the dusk time when DUSK is selected for an on or off time. For example, a user can select turning a light on when DUSK is selected 10 minutes before dusk. That is, a user may desire to turn on outdoor lights 10 minutes before dusk when it starts to dark. Accordingly, a user would have a predetermined amount of time when the DUSK 0 options is displayed. During that predetermined time, such as 5 seconds, a user could use the actuators 1314 and 1316 to select an offset. If a user selected the actuator 1316 once, a DUSK −10 would be selected where the light would be turning on 10 minutes before dusk. If the user wanted to light to be turned on 20 minutes after dusk, the actuator 1314 would be selected twice before the 5 second time out. If neither of the actuators 1314 or 1316 is selected for the timeout period of 5 seconds, selection actuator 1316 can be used to advance to the DAWN programming option, or store a time. Alternatively, the programmable button can be selected to save the DUSK −10 option, for example. An offset can also be selected for DAWN in a similar manner when in the programming screen for selecting DUSK as an on or off time.

Turning now to FIG. 30, a sequence, shown on a display of a programmable light timer, of a review/programming function according to the method of FIG. 28 is shown. In order to check the timing pattern associated with a programmable button, a user would press and hold the programmable button for a predetermined period of time. The programming data associated with the programmable button would be displayed sequentially after timeouts. For example, after the programmable button 1 is selected for a predetermined time to review the timing patterns associated with the button, the on time of 7:30 PM would be displayed for the predetermined time, followed by displaying the off time for the predetermined period of time, before returning to the original screen. However, if one of the actuators 1314 and 1316 is selected while an on or off time associated with the programmable button is displayed, the on or off time can be changed by using the actuators 1314 and 1316 as desired. That is, the review feature cycles through the on and off times, and enables a user to change one of the times associated with the timing pattern. As shown in FIG. 30, the on time can be changed to DUSK −30 (i.e. turning a light on 30 minutes before dusk be using the control actuators to cursor through the DUSK screen). That is, the user can cursor through the on time options to reach the DUSK option, and then adjust the offset time associated with DUSK by selecting an offset within the predetermined period of time after DUSK is reached.

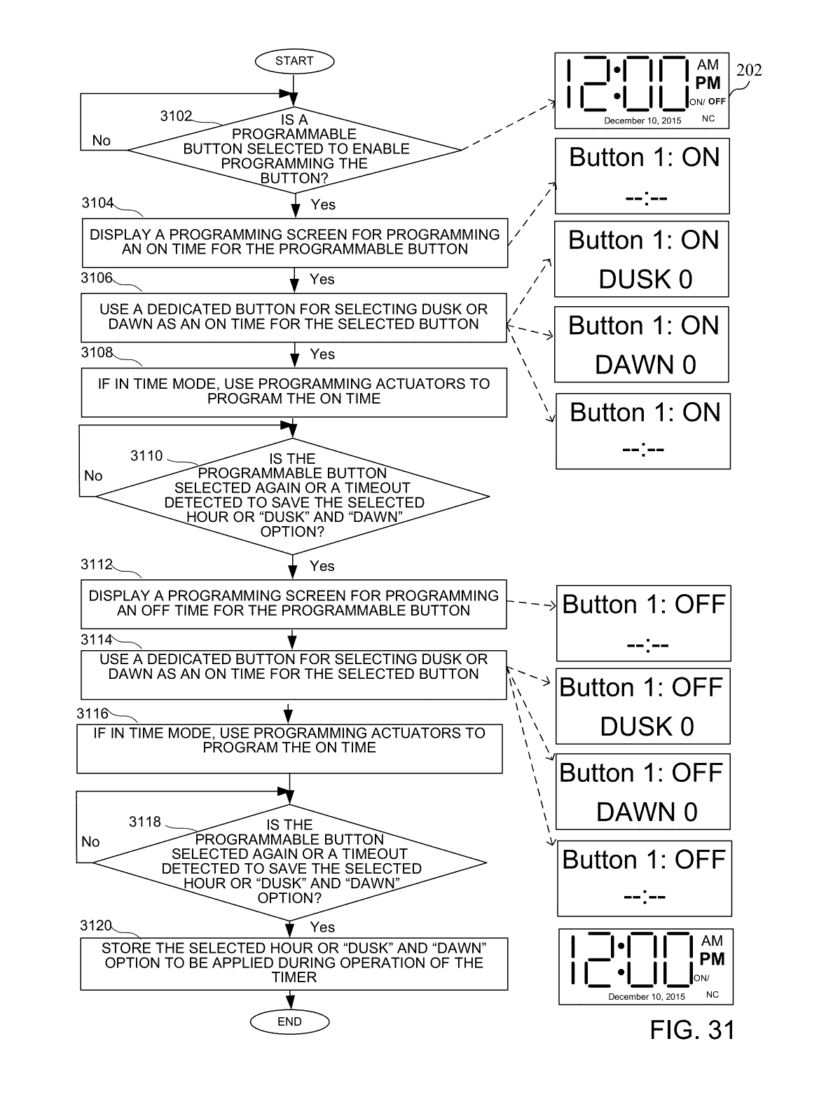

Turning now to FIG. 31, a sequence, shown on a display of a programmable light timer, during the selection of a dusk or dawn time associated with the operation of a dedicated button is shown. It is determined whether a programmable button is selected to enable programming the programmable button at a block 3102. If so, a programming screen is displayed for programming an on time for the programming button at a block 3104. According to the implementation of FIG. 31, a dedicated button, such as the dedicated dusk/dawn actuator 1514 or one of the separate dusk and dawn actuator 1618 and 1620, are used to select dusk or dawn as an on or off time for the timer at a block 3106. That is, the dusk/dawn actuator 1514 can be sequentially selected to move between a dusk programming option, a dawn programming option and a time programming option. If however, the timer is in the mode for selecting a time for an on time as described above at a block 3108, the user can program the on time. It is then determined whether the programmable button selected again or a timeout is detected to save the programmed time or the selected dusk or dawn time at a block 3110.

The programming of the off time for the programmable button is them performed. In particular, if the data associated with the on time is stored at the block 3110, a programming screen is displayed for programming an off time for the programming button at a block 3112. The dedicated dusk or dawn button could also be used to select dusk or dawn as an off time for the timer at a block 3114. If however, the timer is in the mode for selecting a time for an on time as described above at a block 3116, the user can program the on time. It is then determined whether the programmable button selected again or a timeout is detected to save the programmed time or the selected dusk or dawn time at a block 3118. The off time is then stored at the block 3120 to be applied during operation of the timer.

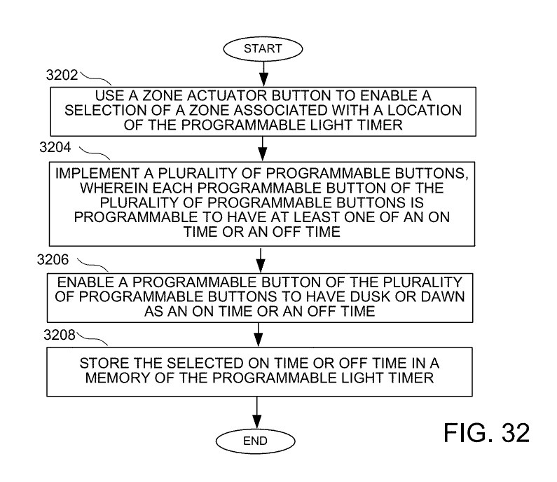

Turning now to FIG. 32, a flow chart shows a method of implementing a programmable timer. In particular, a zone associated with a location of the programmable light timer is selected at a block 3202. A plurality of programmable buttons are implemented at a block 3204, wherein each programmable button of the plurality of programmable buttons is programmable to have at least one of an on time or an off time. A programmable button of the plurality of programmable buttons is enabled to have dusk or dawn as an on time or an off time at a block 3206. The selected on time or off time is stored in a memory of the programmable light timer at a block 3208. The method of FIG. 32 could be implemented using any of the embodiments of FIGS. 1-31, for example.

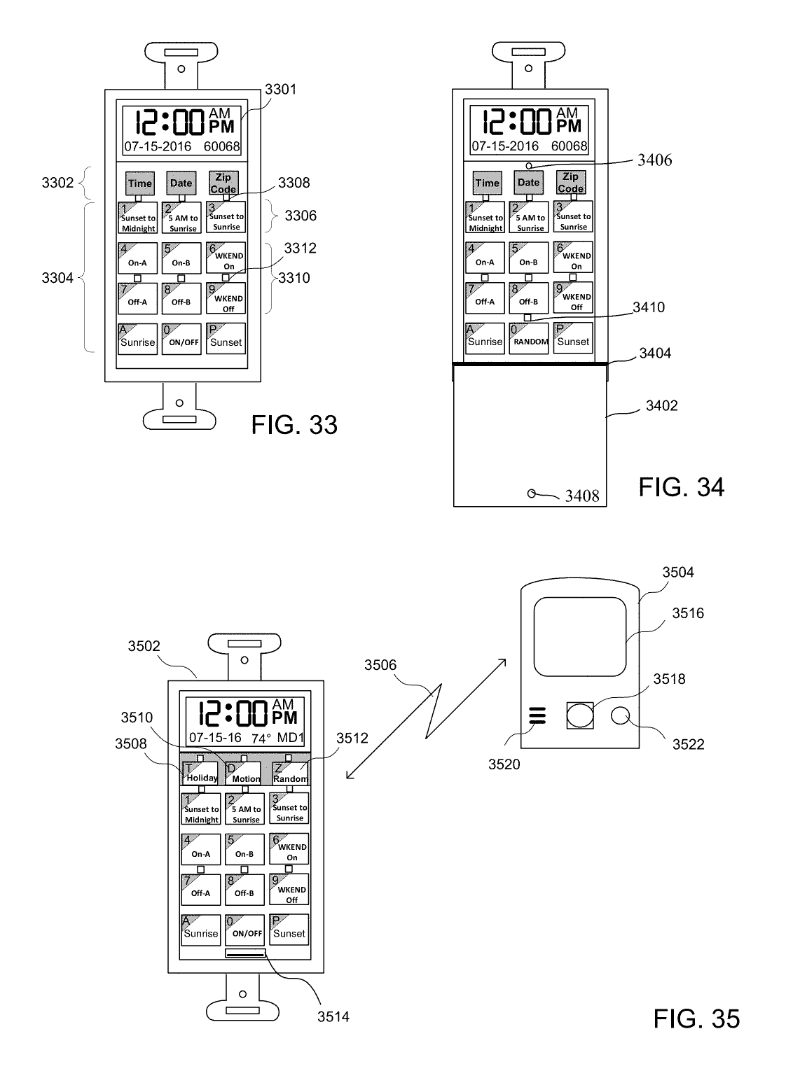

The timer of FIG. 33 enables buttons of a numeric keypad to have multiple functions, and therefore be used to enter numbers associated timing patterns applied by the timer during normal operation. The timer of FIG. 33 comprises a display 3301 that preferably displays time, date and location (such as zip code). The timer also includes 2 sets of keys, including a first set of keys enabling programming and a second set of keys comprising dual-function keys. More particularly, dedicated programming buttons 3302, comprising a time button, a data button, and a location button, shown here as a zip code button, are dedicated programming buttons that enable data to be stored by the timer without having to enter a menu to store the data. By way of example, when the user of the timer wishes to store the current time to be used by the timer to implement a timing pattern (such as by selecting a pre-programmed button or a programmable button as will be described in more detail below), the user would select the time button, for example by depressing the time button for a period of 2 seconds. The correct time, including an AM or PM designation, can then be entered using the numeric keypad 3304. The time can be entered using military time (e.g. 22:00 for 10:00 PM). Alternatively, the buttons on either side of the 0 key that are normally designated are the star (*) and pound (#) buttons can be used as AM (A) and PM (P) buttons, respectively. That is, after entering the desired digits for a time, the A button could be selected for AM. For example, the sequence 715A could be entered for 7:15 AM. The entry can be stored by depressing the Time button for 2 seconds for example. Alternatively, the newly entered data could be stored after the selection of the time button, or if no other changes are made within a predetermined period of time.

The date and the location, such as a zip code, can also be stored. For example, the date can be stored by depressing the date button for 2 seconds to enter a programming mode for the date, and then entering a date in a predetermined format, such as “mmddyyyy” or “mmddyy.” The date can be stored by again depressing the date button for two seconds. Alternatively, the new date could be stored after a predetermined timeout period, or the original date could be retained after the predetermined timeout period, depending upon how the timer is configured. The zip code could be similarly stored by selecting the zip code button for 2 seconds, selecting a 5 digit zip code for example, and then storing by selecting the zip code button.

The dual function keys of the numeric keypad 3304 comprise pre-programmed buttons 3306, each of which has a corresponding LED light 3308 indicating whether the button has been selected. The numeric keypad also includes programmable buttons 3310 that enable the programming of on and off times implemented by the timer. For example, the pair of number 4 and number 7 numeric buttons provide a first set on and off timers, designed On-A and On-B which have a corresponding LED indicator between them to indicate that the pair that has been selected. The pair would be selected and the LED would be turned on if either button of the pair is selected. A second pair of on and off times designated as On-B and Off-B can be implemented using number buttons 5 and 8. A third pair of on and off times can be implemented using the number keys 6 and 9, where the third pair of keys are designated as WKEND On and WKEND Off and would be activated for example on Friday and Saturday evenings. The weekend on and off times would take priority over the first and second pairs of on and off times if there is a conflict. While the programmable buttons according to the implementation of FIG. 33 are associated with on and off times that relate only to a single on or off time, it should be understood that the individual buttons could be programmed to store both on and off times as set forth above.

A button of the one of the programmable buttons (i.e. buttons 4, 7, 5, 8, 6, and 9) can be programmed with a fixed on time or off time in the same manner that the time for the timer is programmed after selecting the time button as described above. That is, when the user of the timer wishes to program a programmable button to be used by the timer to implement a timing pattern, the user would select the time button, for example by depressing the time button for a period of 2 seconds. The correct time, including an AM or PM designation, can then be entered using the numeric keypad 3304. The time can be entered using military time (e.g. 22:00 for 10:00 PM). Alternatively, the buttons on either side of the 0 key that are normally designated are the star (*) and pound (#) buttons can be used as AM (A) and PM (P) buttons, respectively. That is, after entering the desired digits for a time, the A button could be selected for AM. For example, the sequence 715A could be entered for 7:17 AM. The entry can be stored by depressing the programmable button for 2 seconds for example.

Rather than storing a specific on or off time, the particular on and off times can be programmed to turn on or off at sunrise or sunset. More particularly, after selecting one of the programmable buttons (i.e. buttons 4, 7, 5, 8, 6, and 9) for a predetermined period of time to enter a programming mode, if a user then selects a number button, a fixed time will be stored in response to a storing action (i.e. pressing the button again or waiting for a time-out period). However, if a user desires an on or off time associated with a programmable button to turn on or off at sunrise or sunset, the user would select either the sunrise button (i.e. the button on the left of the zero button that is otherwise the star (*) key in a conventional numeric keypad (designated as the AM (A) key) after a programmable button) or the sunset button (i.e. the button on the right of the zero button that is otherwise the pound (#) key in a conventional numeric keypad (designated as the PM (P) key) after selecting a programmable button). The user would then select the programmable button again for a predetermined period of time (e.g. 2 seconds) to store the sunrise or sunset setting for providing an on or off time for the programmable button which would be used if the button were later selected for operation of the timer. Because the zero button does not provide any additional function associated with the operation of the timer, it can be used as an on/off button to enable turning a light or other appliance attached to the timer on when it is off or turning the light or other appliance attached to the timer off when it is on. It should be noted that a user can check the on or off time of the programmable buttons (i.e. number buttons 4, 5, 7, and 8) by selecting the button for a predetermined period of time as if to program the button. The currently stored time will be displayed, enabling the user to decide to keep that time by taking no further action for a predetermined timeout period, after which the display will revert to a normal operational mode, or to change a current setting by selecting a button to start the programming operation.

As shown in FIG. 34, a cover 3402 is provided to cover the buttons and enable turning the light on and off. More particularly, the cover 3402 is attached to the timer by a hinge 3404, and is movable to engage an on/off button 3406 that is in contact with a projection 3408. By providing an on/off feature using a cover, the zero button can then be used another functional feature of the timer during a normal operation. For example, the zero button can be a dual-function button that can be used to provide a random function, where the selection of the random function would be designated by an LED 3410. The random function would randomly turn a light controlled by a timer on or off during evening hours, and even at times during which the timer is set to be on. The random feature provides an appearance that someone is home and that the light is not controlled by a timer.

According to another implementation of a timer, a motion detector can be paired with the timer. Further, the time, date and zone buttons that are not designated as a dual function key for programming or being programmed (i.e. either pre-programmed or programmable) can provide other functional features during operation of the timer. More particularly, a timer 3502 is coupled to receive signals from a motion detector 3504. The signals may be provided by way of wireless connection 3506, such as a Bluetooth connection for example. The time (T), date (D) and zone (Z) buttons can be implemented as dual function buttons which are responsive to a long press (e.g. pressing and holding for a 2 second period) operation to enter a programming mode. However, when not in a programming mode, the time, date and zone programming buttons can enable or disable a timing feature of the timer. For example, the time programming button 3508 can also enable a timer to follow a normal pattern if the light or appliance attached to the timer is automatically turned off on a holiday. That is, some timers may automatically turn off a light during a holiday. Accordingly, it may be beneficial to enable a user to be able to case the timer to revert to timer mode, such as the selected pre-programmed or programmed options that may be selected and implemented if it were not a holiday. Accordingly, the time button 3508 could function as a holiday button that would enable a user to override the holiday setting and follow a normal timing pattern. An LED indicator would indicate whether the holiday override feature is selected. It should be noted that the holiday override feature could be selected for a single holiday, and would turn off again after the holiday is over, requiring the feature to be selected again at the next holiday if the override feature is desired then.

The date (D) button 3510 can also provide a second function of enabling operation of a motion detector that is paired with the timer, while the zone button 3512 could function to enable a random mode of operation. The motion detector 3504 comprises a motion sensor portion 3516, a camera 3518, a temperature sensor 3520, and a programming button 3522. The timer 3502 could be paired with the motion detector 3504 by selecting buttons on one or more of the timer 3502 and the motion detector 3504. For example, both the motion detector button 3510 and the programming button 3522 of the motion detector 3504 could be held for a predetermined period of time, such as five seconds or until an indication is given that the timer and the motion detector have been paired. The indication can be given by a sound, such as a beep, or an indication on the display of the timer. For example, the MD1 (motion detector 1) indicator on the display, which may be shown in a light gray indicating that there is no pairing, may be flashing during the pairing process, and then be shown in black when the devices are paired. The user can then release the buttons after an indication is given that the timer and the motion detector are paired. The dual-function motion button can also enable the selection of an “on time” for the light after motion is detected. For example, the motion button can be sequentially selected for an off operation or an on operation having 1 minute, 2 minutes, 5 minutes and 10 minute on times, which would be displayed on the screen when selecting the motion button. The corresponding LED would be off if the motion detection feature is turned off, but would be on if any one of the selectable time periods is selected. One beneficial aspect of the pairing indicator MD1 is that a user can determine whether the motion detector is within range of the timer. This will allow a user to determine whether the motion detector is placed within range of the timer, and therefore provide useful motion sensing information to the timer. As will be described in more detail below, a second motion detector could also be added, and therefore provide greater coverage of motion detection for a given timer.

According to another feature, the camera on the motion detector can record images, which may include still frame images or video images, when motion is detected. The images may be downloaded to a memory of the timer as the images are recorded, or may be stored on a memory of the motion detector, and then later downloaded to a memory of the timer. The recorded images can then be downloaded to a portable memory, such as a USB thumb drive, by way of a connector 3514, shown here as a USB connector. While a USB connector as shown by way of example, it should be understood that any type of portable memory, such as an SD memory or any other type of Flash memory device, could be used. The images that are stored could be stored on a first-in first-out basis, where the oldest images would be written over to receive new images. Accordingly, the most recent images will always be available on the memory. Alternatively or in addition to downloading the images to the timer, images stored on the motion detector could be accessed by way of another communication link, such as a separate Bluetooth connection to a mobile device, such as a smart phone, or by way of a physical connection to a connector of the motion detector. Similarly, the motion detector can transmit a temperature recorded by the temperature sensor 3502 to the timer 2502. As shown in the display of the timer 3502, the temperature of 74° has been recorded by the motion detector. Such functionality can be beneficial for the use of motion detector both inside and outside.

Therefore, great functionality is provided to the timer with simple interface. While only two functions are shown, it should be understood that more than two functions could be implemented. A third function could be implemented for example by applying a different button selection process, such as a five second press and hold time. Further, while the timers of FIGS. 33 and 34 are shown as in-wall timers, it should be understood that the timers could be a plug-in timer or to implement a timing function on any type of device. As will be described in more detail below, multiple motion detectors, as well as multiple timers can communicate by way of Bluetooth connections directly between a timer and a motion detector.

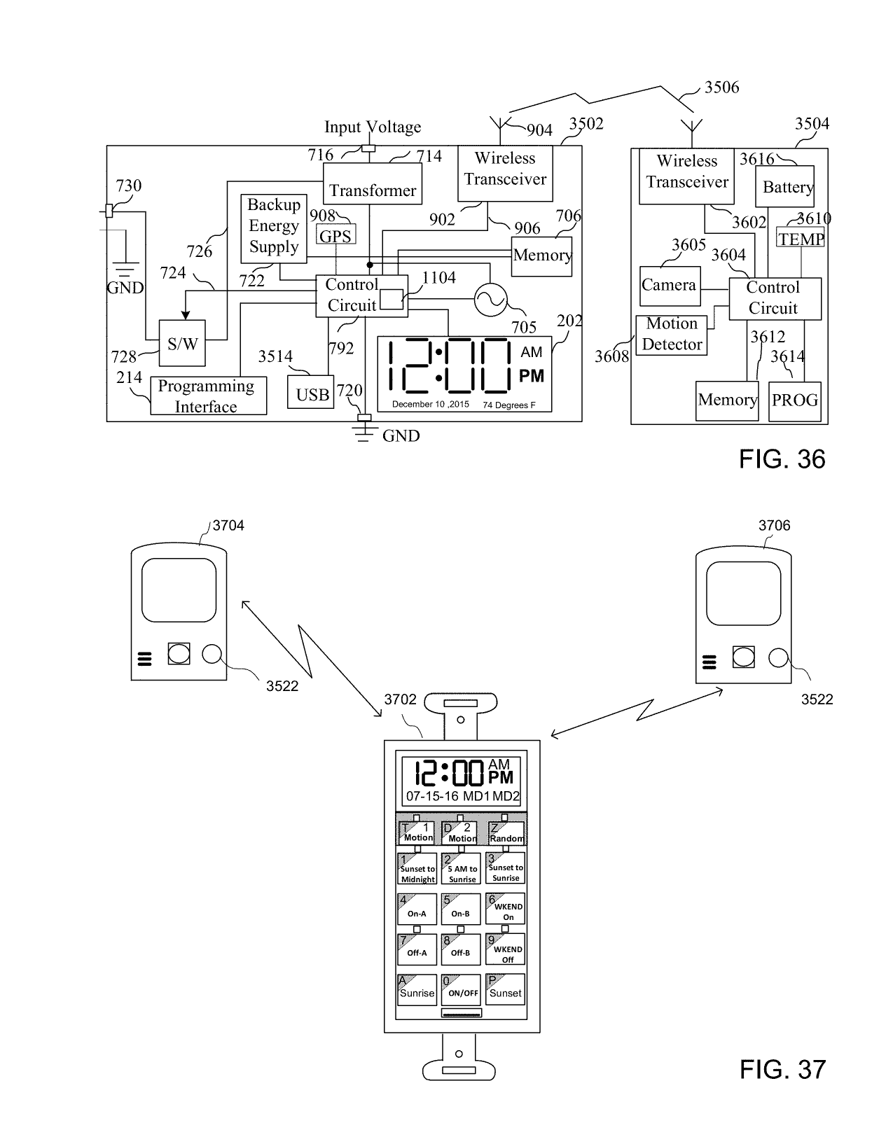

However, before describing implementations of multiple motion detectors and timers, FIG. 36 shows the configuration of the timer 3502 and the motion detector 3504 connected by a communication link 3506. The motion detector 3504 comprises a wireless transceiver 3602 that communicates with the wireless transceiver 902 of the timer 3502. As set forth above, the communication link can be any type of wireless communication link, such as a Bluetooth communication link. The motion detector also comprises a control circuit 3604 which is coupled to various elements for receiving data or maintaining the operation of the motion detector. For example, the control circuit 3604 is coupled to a camera 3605, a motion detector element 3608, a temperature sensor 3610, a memory 3612, a programming button 3614, and a battery 3616. The control circuit 3604 enables the camera to be activated whenever the motion detector element 3608 senses motion within a range of the motion detector. The memory can act as a buffer to store any images captured by the camera, to enable the motion detector to download the images to the timer, or can act as a backup memory in the event the images are corrupted in the memory of the timer. The programming button 3614 can be used to enable the pairing of the motion detector in the timer as set forth above. The timer 3502 corresponds generally to the timer of FIG. 9, but includes a USB connector 3514.

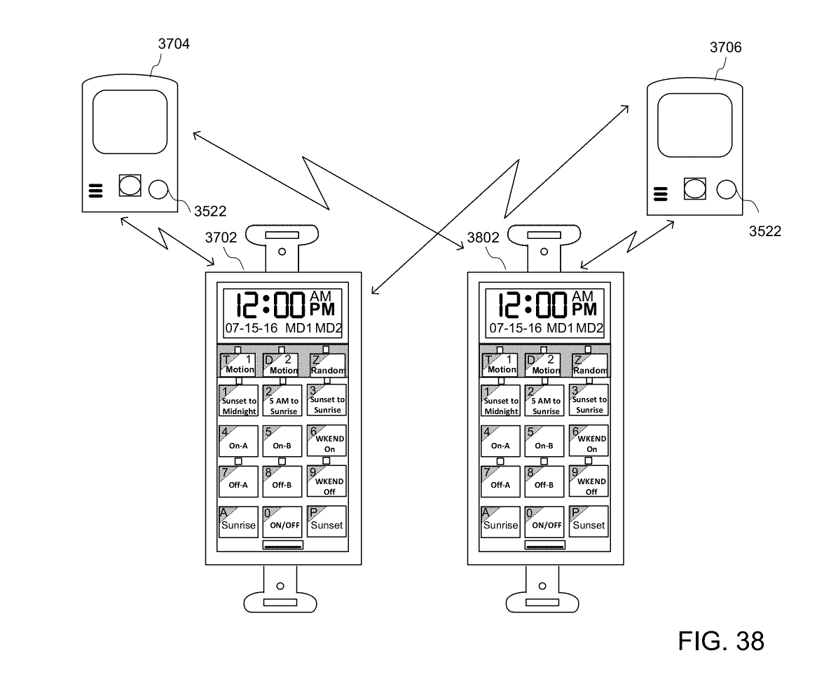

As shown in the embodiment of FIG. 37, a timer 3702 can be coupled to multiple motion detectors, shown here as a first motion detector 3704 and a second motion detector 3706. Each of the motion detectors can be implemented as the motion detector 3604 described above in reference to FIG. 36. As can be seen on the display of the timer 3702, separate indicators MD1 and MD2 are provided to indicate whether each of the motion detectors is connected by a communication link to the timer. As also shown in the keypad portion of the timer, separate buttons associate with the first motion detector (MD1) and the second motion detector (MD2) to can be selected to determine whether to maintain a communication link to the supper motion detectors. Such a feature is more significant in the operation of a system having multiple motion detectors with multiple timers described in reference to FIG. 38.

As shown in FIG. 38, an additional timer 3802 is implemented. Because each motion detector may be coupled to two separate timers, is necessary to designate a particular timer associated with a motion detector. That is, it may be beneficial to only download the images to one of the timers to conserve memory space. Accordingly, the timer which is first pair with a motion detector will be considered the primary timer for the motion detector, and the images from a given motion detector will be downloaded only to the primary timer. By way of example, the timer 3702 may be the primary timer for the motion detector 3704, and therefore will download images only to the timer 3702. While both the first timer 3702 and the second timer 3802 may receive motion detection signals from each of the motion detectors, images will only be downloaded to one timer. Alternatively, the video images could be downloaded to both timers. One beneficial aspect of the arrangement of FIG. 38 is that different lights around the perimeter of a house could be turned on in response to the detection of motion in one portion of the house. For example, lights in both the front of the house and the rear of the house may be turned on in response to detection of motion in the rear the house. Alternatively, the motion detectors can be placed at any location on the house and enable the operation of each of the timers. While the displays indicate that both motion detectors are within range of both timers, it could be that one motion detector may be in range of both timers, and the other motion detector only within range of one of the timers. Also, the timers and motion detectors do not need to be within range of each other, but can also be connected by way of a mesh network, where any given device only needs to be within range of any other device, enabling the devices to be further apart. Such mesh networks are available from a company CSR in Cambridge, United Kingdom, which is a subsidiary of Qualcomm, Inc.

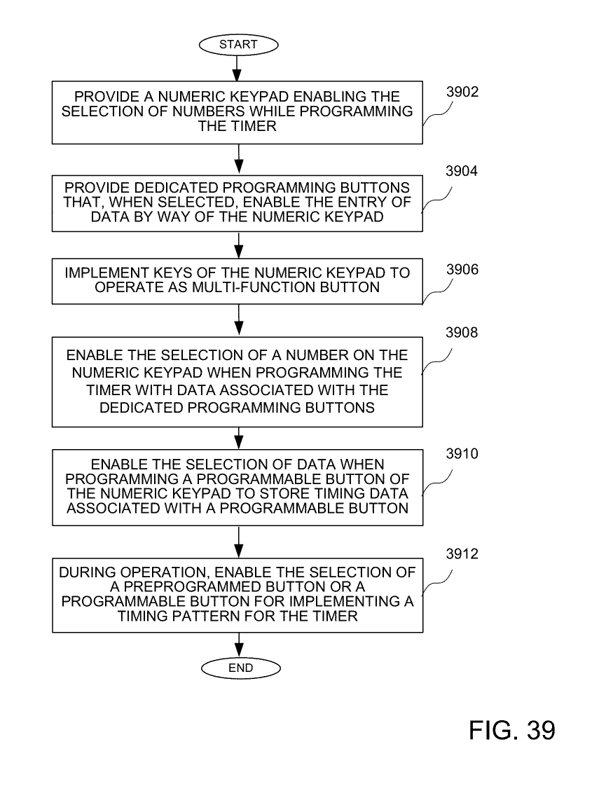

Turning now to FIG. 39, a method of implementing a numeric keypad having multi-functional keys is shown. A numeric keypad enabling the selection of numbers while programming the timer is provided at a block 3902. Dedicated programming keys that, when selected, enable the entry of data by way of a numeric keypad are provided at a block 3904. Keys of the numeric keypad are implemented to operate as multi-function keys. at a block 3906. The selection of a number on the numeric keypad when programming the timer with data associated with the dedicated programming keys is enabled at a block 3908. The selection of data when programming a programmable key of the numeric keypad to store timing data associated with a programmable key is enabled at a block 3910. During operation, the selection of a preprogrammed key or a programmable key for implementing a timing pattern for the timer is enabled at a block 3912.

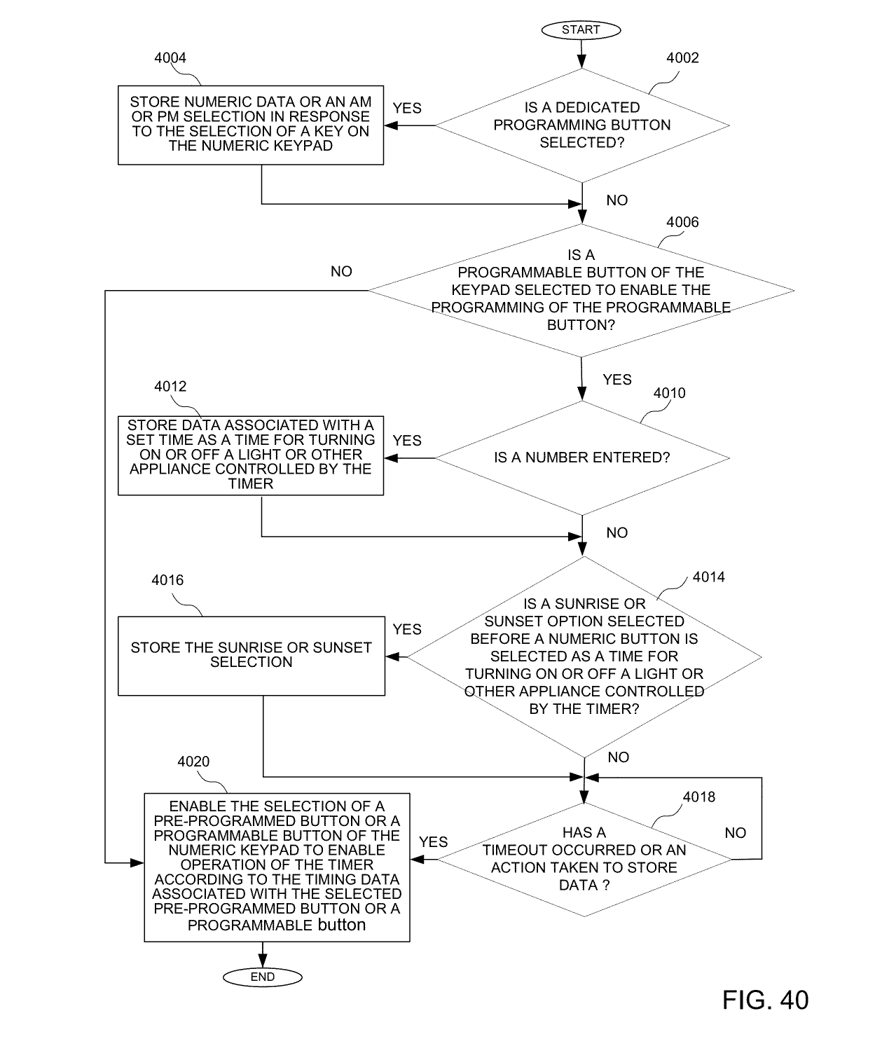

Turning now to FIG. 40, a flow chart shows a method of programming a programmable button of a timer. It is determined whether a dedicated programming button is selected at a block 4002. Numeric data or an AM or PM selection are stored in response to the selection of a key on the numeric keypad at a block 4004. It is then determined whether a programmable button of the keypad is selected to enable the programming of the programmable button at a block 4006. It is also determined whether a number entered at a block 4008. If so, data associated with a set time is stored as a time for turning on or off a light or other appliance controlled by the timer at a block 4010. It is then determined whether a sunrise or sunset option is selected before a numeric button is selected as a time for turning on or off a light or other appliance controlled by the timer at a block 4012. If so, the sunrise or sunset selection is stored at a block 4014.

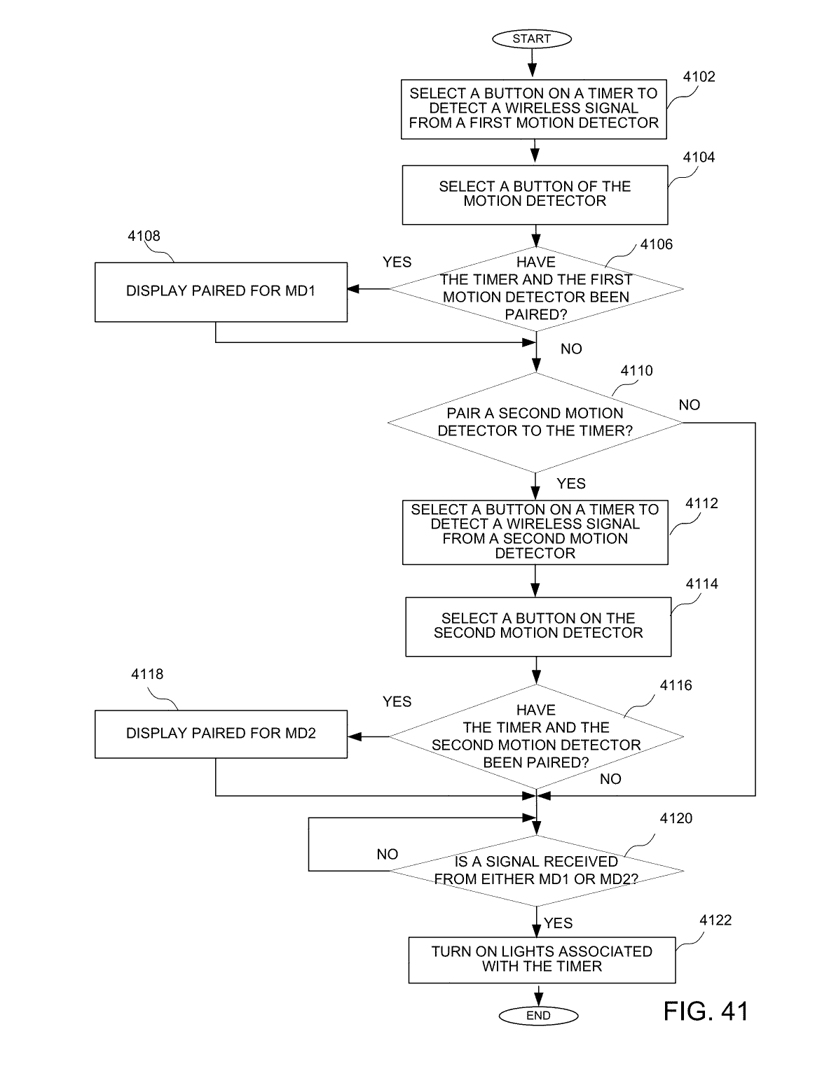

Turning now to FIG. 41, a method of enabling the operation of two motion detectors associated with a timer is shown. A button on a timer to detect a wireless signal from a first motion detector is selected at a block 4102. A button of the motion detector is selected at a block 4104. It is then determined whether the timer and the first motion detector have been paired at a block 4106. If so, an indication that the timer and the first motion detector MD1 is displayed at a block 4108. It is then determined whether a second motion detector is to be paired with the timer at a block 4110. A button on a timer is selected to detect a wireless signal from a second motion detector at a block 4112. A button on the second motion detector is then selected at a block 4114. It is then determined whether the timer and the second motion detector have been paired at a block 4116. If so, an indication on the display is provided to indicate that the timer is paired with the second motion detector MD2 at a block 4118. It is then determined whether a signal is received from either MD1 or MD2 at a block 4120. Lights associated with the timer are turned on at a block 4122 in response to a signal from the motion detector of based upon the selection of a pre-programmed button or a programmable button.

The methods of FIGS. 39-41 may be implemented in any of the timer or timer arrangements of FIGS. 33-38, or other suitable timer or timer arrangement. While various aspects and arrangements of the timers and motion detectors are disclosed in different implementations by way of example, it should be understood that features in one particular embodiment may be included in another embodiment.

It can therefore be appreciated that the new and novel timer and method of implementing a timer has been described. It will be appreciated by those skilled in the art that numerous alternatives and equivalents will be seen to exist which incorporate the disclosed invention. While various features are disclosed in different embodiments, it should be understood that features in a particular embodiment could be implemented in another embodiment. That is, various features can be interchanged in different implementation to provide improved programming of programmable timers, and particularly the programming of astronomic times for on and/or off times. As a result, the invention is not to be limited by the foregoing implementations, but only by the following claims.

I claim:

1. A programmable light timer for implementing a timing pattern, the programmable light timer comprising:
a numeric keypad enabling the selection of data for programming the programmable light timer; and
a programming interface having one or more buttons enabling a selection of an on time or an off time associated with a button for implementing the timing pattern;
wherein the on time or the off time associated with the button is programmable suing the numeric keypad.

2. The programmable light timer of claim 1 wherein the programming interface enables selecting either dusk or dawn as an on time or an off time of the timing pattern.

3. The programmable light timer of claim 1 further comprising dedicated programming buttons for entering current data associated with the programmable light timer.

4. The programmable light timer of claim 3 wherein the dedicated programming buttons comprise at least one of a time programming button, a date programming button and a location programming button.

5. The programmable light timer of claim 1 wherein the one or more buttons enabling a selection of an on time or an off time associated with a button for implementing the timing pattern comprises a preprogrammed button.

6. The programmable light timer of claim 1 wherein the one or more buttons enabling a selection of an on time or an off time associated with a button for implementing the timing pattern comprises a programmable button.

7. The programmable light timer of claim 1 further comprising a button for overriding the timing pattern.

8. A programmable light timer for implementing a timing pattern, the programmable light timer comprising:
a numeric keypad enabling the selection of data for programming the programmable light timer; and
a programming interface having one or more dedicated programming buttons enabling a selection of data associated with implementing the timer;
wherein buttons of the numeric keypad comprise multi-function buttons that enable the selection of a number associated with a button during a programming operation and a timing pattern during a timing operation.

9. The programmable light timer of claim 8 wherein the buttons of the numeric keypad are multi-function buttons.

10. The programmable light timer of claim 8 wherein the buttons of the numeric keypad comprise preprogrammed buttons.

11. The programmable light timer of claim 8 wherein the buttons of the numeric keypad comprise programmable buttons.

12. The programmable light timer of claim 8 wherein the buttons of the numeric keypad comprise functional buttons.

13. The programmable light timer of claim 12 wherein the functional buttons comprise at least one of an on/off button and a random button.

14. The programmable light timer of claim 8 wherein the dedicated programming buttons comprise at least one of a time programming button, a date programming button and a location programming button.

15. A programmable light timer for implementing a timing pattern, the programmable light timer comprising:
a numeric keypad enabling the selection of data for programming the programmable light timer; and
a programming interface having one or more dedicated programming buttons enabling a selection of data associated with implementing the timer;
wherein buttons of the numeric keypad comprise multi-function buttons that enable the selection of a number associated with a button during a programming operation and a timing pattern during a timer operation.

16. The programmable light timer of claim 15 wherein the programming interface enables selecting either dusk or dawn as an on time or an off time of the timing pattern.

17. The programmable light timer of claim 15 wherein the dedicated programming buttons comprise at least one of a time programming button, a date programming button and a location programming button.

18. The programmable light timer of claim 15 wherein the one or more buttons of the numeric keypad comprises a preprogrammed button.

19. The programmable light timer of claim 15 wherein the one or more buttons of the numeric keypad comprises a programmable button.

20. The programmable light timer of claim 15 further comprising a button for overriding the timing pattern.
